(19) United States
(12) Patent Application Publication
(10) Pub. No.: US 2005/0100274 A1
(43) Pub. Date: May 12, 2005

(54) Light dispersion compensating element and composite type light dispersion compensating element using that element and light dispersion compensating method using that element

(76) Inventors: Shiro Yamashita, Saitama-ken (JP); Noboru Higashi, Saitama-ken (JP)

Correspondence Address: NIXON & VANDERHYE, PC, 1100 N GLEBE ROAD, 8TH FLOOR, ARLINGTON, VA, 22201-4714, US

(21) Appl. No.: 10/398,576

(22) PCT Filed: Oct. 12, 2001
(86) PCT No.: PCT/JP01/08978

(30) Foreign Application Priority Data
Oct. 13, 2000 (JP) 2000-314297

(51) Int. Cl. G02B 6/26; G02B 6/02

(52) U.S. Cl. 385/27; 385/123

(57) ABSTRACT

In the past, the occurrence of wavelength dispersion in signals transmitted through optical fibers caused considerable problems in terms of communications at a communications bit rate of 10 Gbps or more, and particularly optical communications at 40 Gbps or more. In the present invention, an optical dispersion compensating element can be realized having a group velocity delay time vs. wavelength characteristics curve in which the extreme value of group velocity delay time is large over a broad bandwidth by composing a compound optical dispersion compensating element containing optical dispersion compensating elements in which a reflector Or multi-layer film element is disposed in opposition to the incident surface of a multi-layer film element capable of performing dispersion compensation by utilizing group velocity delay time vs. wavelength characteristics, and connecting a plurality of elements capable of performing dispersion compensation in series. According to the present invention, dispersion compensation for each channel as well as dispersion compensation of a plurality of channels is performed.

### TECHNICAL FIELD

In the following explanation of the present invention, optical dispersion compensation is simply referred to as dispersion compensation, an optical dispersion compensating element is simply referred to as a dispersion compensating element, and an optical dispersion compensation method is simply referred to as a dispersion compensation method. In addition, a compound optical dispersion compensating element composed of the optical dispersion compensating element of the present invention and a reflector, or composed of a plurality of optical dispersion compensating elements of the present invention, is also simply referred to as an optical dispersion compensating element or dispersion compensating element when it can be clearly judged as such from the explanation.

The present invention relates to a dispersion compensating element comprising an element capable of compensating for wavelength dispersion (hereinafter to simply be referred to as dispersion) of the second order or more (to be described later) occurring in optical communications using an optical fiber (hereinafter to simply be referred to as a fiber) for the transmission path, and light having a wavelength of, for example, 1.55 mm for the signal light (an element capable of compensating second order dispersion) is hereinafter to simply be referred to as an element able to vary second order dispersion or a second order dispersion compensating element, and simultaneously, an element capable of compensating third order dispersion to be described later is similarly hereinafter to simply be referred to as an element able to vary third order dispersion or a third order dispersion compensating element), a compound optical dispersion compensating element having low loss and disposing a dispersion compensating element and reflector in opposition or disposing at least one pair of dispersion compensating elements in opposition to the incident surface of the light, and an optical dispersion compensation method that is carried out by using an element, and the like composed in the same manner as described above.

There are also cases in which the dispersion compensating element and compound dispersion compensating element using that element of the present invention are only the third order dispersion compensating element described above, cases in which the elements may be composed so as to be capable of not only third order dispersion compensation but also second order dispersion compensation, cases in which they may contain a means for changing the incident position of incident light in a direction within the incident surface to be described later, cases in which they are mounted in a case, and cases in which they are in the form of a so-called chip or wafer that is not mounted in a case.

In the present invention, second order dispersion compensation refers to “compensating the slope of a wavelength versus time characteristics curve to be described later using FIG. 13A”, and third order dispersion compensation refers to “compensating the curvature of a wavelength versus time characteristics curve to be described later using FIG. 13A”.

### BACKGROUND ART

In optical communications using optical fibers for the communications transmission path, together with progress of the technology used and expansion of the range of utilization, there is a need for increased distance of the communications transmission path and increased speed of the communications bit rate. In such an environment, the dispersion that occurs when transmitting over optical fibers becomes a serious problem, and various attempts have been made to compensate for that dispersion. Thus far, second order dispersion has become a serious problem, and various proposals have been made for its compensation, several of which have been effective.

However, as the demands being placed on optical communications become increasingly severe, compensation of second order dispersion alone during transmission has become insufficient, and compensation of third order dispersion is becoming an important topic.

The following provides an explanation of a conventional method of compensating for second order dispersion using FIGS. 13A through 13C and FIG. 14.

FIG. 14 is a drawing that explains the dispersion vs. waveform characteristics of a single mode optical fiber (abbreviated as SMF), dispersion compensating fiber and dispersion shift fiber (abbreviated as DSF). In FIG. 14, reference symbol 601 indicates a graph of the dispersion-waveform characteristics of an SMF, reference symbol 602 indicates a graph of the dispersion vs. waveform characteristics of a dispersion compensating fiber, and reference symbol 603 indicates a graph of the dispersion vs. waveform characteristics of a DSF. In the graphs, dispersion is plotted on the vertical axis and wavelength is plotted on the horizontal axis.

As is clear in FIG. 14, in the SMF, as the wavelength of the light that is input to the fiber (hereinafter to also be referred to light that enters the fiber) becomes longer from 1.3 mm to 1.8 mm, dispersion increases, while in the dispersion compensating fiber, as the wavelength of the input light (hereinafter to also be refined to as incident light) becomes longer from 1.3 mm to 1.8 mm, dispersion decreases. In the DSF, as the wavelength of the input light becomes longer from 1.2 mm to around 1.55 mm, dispersion decreases, and as the wavelength of the input light increases from around 1.55 mm to 1.8 mm, dispersion increases. In the DSF, in optical communications at conventional communication bit rate oil the order of about 2.5 Gbps (2.5 gigabits per second), dispersion does not present a problem in optical communications for a wavelength of input light around 1.55 mm.

FIGS. 13A through 13C are drawings that explain a method of compensating primarily second order dispersion. FIG. 13A explains wavelength vs. time characteristics and optical intensity-time characteristics. FIG. 13B explains a transmission example in which second older dispersion compensation is performed using a dispersion compensating fiber in a transmission path using SMF, while FIG. 13C explains a transmission example in a transmission path composed of only SMF.

In FIGS. 13A through 13C, reference symbols 501 and 511 are graphs showing the characteristics of signal light prior to being input into the transmission path, reference symbol 530 indicates a transmission path composed of SMF 531, reference symbols 502 and 512 are graphs showing the characteristics of a signal light in which the signal light having the characteristics shown in graphs 501 and 511 is transmitted along transmission path 530 and output from transmission path 530, reference symbol 520 is a transmission path composed of dispersion compensating fiber 521 and SMF 522, and reference symbols 503 and 513 are graphs showing the characteristics of a signal light in which the signal light having the characteristics shown in graphs 501 and 511 is transmitted along transmission path 520 and output from transmission path 520. Reference symbols 504 and 514 are graphs showing the characteristics of signal light when signal light having the characteristics shown in graphs 501 and 511 is transmitted along transmission path 520, output from transmission path 520, and then subjected to the desirable third order dispersion compensation described later according to the present invention, and closely coincide with graphs 501 and 511. In addition, graphs 501, 502, 503, and 504 each have wavelength plotted on the vertical axis and time (or actual time) plotted on the horizontal axis, while graphs 511, 512, 513, and 514 each have optical intensity plotted on the vertical axis and time (or actual time) plotted oil the horizontal axis. Furthermore, reference symbols 524 and 534 indicate transmitters, while reference symbols 525 and 535 indicate receivers.

As was previously described, since in the case of conventional SMF, dispersion increases as the wavelength of the signal light becomes longer from 1.3 mm to 1.8 mm, during high-speed communications or long-distance transmissions, a delay occurs in the group velocity caused by dispersion. In transmission path 530 composed of an SMF, the signal light is delayed considerably at longer wavelengths more than at shorter wavelengths during transmission, and becomes as shown in graphs 502 and 512. Signal light that has varied in this manner may be unable to be accurately received as a single as a result of being unable to be distinguished from the signal light before and after it in, for example, high-speed communications or long-distance transmissions.

In the past, in order to solve such problems, dispersion was compensated (or corrected) by using, for example, a dispersion compensating fiber as shown in FIG. 13B.

Dispersion compensating fibers of the prior art were made so that dispersion decreased as the wavelength became longer from 1.3 mm to 1.8 mm as previously described in order to solve the problem of SMF in which dispersion increases as the wavelength becomes longer from 1.3 mm to 1.8 mm.

As shown with transmission path 520 of FIG. 13B for example, dispersion compensating fibers can be used by connecting dispersion compensating fiber 521 to SMF 522. In the above transmission path 520, since the signal light is considerably delayed at longer wavelengths as compared with shorter wavelengths in SMF 522, and is then considerably delayed as shorter wavelengths as compared with longer wavelengths in dispersion compensating fiber 521, as shown in graphs 503 and 513, the amount of variation can be held to a lower level than the variation indicated in graphs 502 and 512.

However, in a compensation method for second order wavelength dispersion of the prior art described above that uses a dispersion compensating fiber, dispersion compensation of signal light that has been transmitted along a transmission path cannot be performed in the state of the signal light prior to being input into the transmission path, namely until the shape of graph 501, and that compensation is limited to until the shape of graph 503. As shown in graph 503, in the compensation method for second order wavelength dispersion of the prior art that uses a dispersion compensating fiber, light having a center wavelength of the signal light is not delayed in comparison with light having a shorter wavelength or light having a longer wavelength, while only the light of components having a shorter wavelength or longer wavelength than the light of the center wavelength component of the signal light is delayed. As shown in graph 513, ripple may occur in a portion of the graph.

These phenomena are becoming serious problems including the prevention of accurate signal reception accompanying greater needs for longer transmission distances and faster communication speeds of optical communications. For example, in the case of high-speed communications in which signals are transmitted at a communications bit rate of 40 Gbps (40 gigabits per second) over a distance of 10,000 km or high-speed communications in which signals are transmitted at 80 Gbps over a distance on the older of several thousand km, these phenomenon are a cause of considerable concern and are viewed as extremely serious problems. In such high-speed communications and long-distance communications, the use of conventional optical fiber communication systems is considered to be difficult. For example, these phenomena are also becoming a serious problem from an economic standpoint of system construction, such as even resulting in a need to vary the material of the optical fibers themselves.

Since it is difficult to compensate for this dispersion by second order dispersion compensation alone, third order dispersion compensation becomes necessary.

In the past, although DSF were used as optical fibers that reduce second order dispersion for light having a wavelength around 1.55 mm, as is clear from the previously mentioned characteristics of FIG. 13A and FIG. 14, this fiber does not allow the third order dispersion compensation that is an object of the present invention.

In the realization of faster communication speeds and longer communication distances of optical communications, there is a growing awareness that third order dispersion presents a significant problem, and its compensation is becoming an important topic. Although numerous attempts have been made to solve the problem of compensation of third order dispersion, a third order dispersion compensating element or compensation method capable of adequately solving the problems of the prior art has yet to be used practically.

Although an example of using a fiber that forms a diffraction grating has been reported as a method for compensating third order dispersion, this method has fatal shortcomings such as being able to achieve the necessary compensation, having large loss and having a large geometry. Moreover, the fiber is expensive and cannot be expected to be used practically.

As an example of the above third order dispersion compensation, the inventors of the present invention succeeded in compensation of third order dispersion to a certain extent by using a compact optical dispersion compensating element that used a multi-layer film of a dielectric substance and so forth, and were able to greatly advance the optical communications technology of the prior art.

However, in order to ideally perform third order dispersion compensation in the case of high-speed communications at a communications bit rate of 40 Gbps or 80 Gbps and so forth, or to adequately perform third order dispersion compensation in Multi-channel optical communications, a dispersion compensating element or dispersion compensation method is desired that is able to adequately compensate second order and third order dispersion over an even broader wavelength band.

As one proposal for this, a third order dispersion compensating element was proposed that is able to adjust the wavelength band of group velocity delay and the delay time of group velocity delay. In particular, a variable wavelength (namely, allowing selection of the wavelength for dispersion compensation) dispersion compensating element was proposed as one way of inexpensively realizing a practical third order dispersion compensating element that is also suitable for the wavelength of each channel.

However, it is quite difficult to obtain a dispersion compensating element having group velocity delay time vs. wavelength characteristics that enable adequate dispersion compensation in broad wavelength bands with these dispersion compensating elements.

As a method of obtaining a dispersion compensating element having group velocity delay time vs. wavelength characteristics that enable satisfactory dispersion compensation over a broad wavelength band, a method was proposed by the inventors of the present invention in which a plurality of elements capable of performing dispersion compensation are connected in series in the optical path of a signal light. In this case, if elements capable of dispersion compensation are connected in series via, for example, an optical fiber collimator having an optical fiber and lens, the geometry of the overall dispersion compensating element becomes larger, and its loss increases. Consequently, depending on the conditions under which the dispersion compensating elements are used, the extent to which the loss of the dispersion compensating elements can be reduced becomes an important issue.

In the case of composing an optical dispersion compensating element that can be used for a broad wavelength band of, for example, 10 nm or 30 nm, by connecting a plurality of elements capable of performing dispersion compensation in series in an optical path, it is desirable that a method for composing the dispersion compensating elements be realized that results in compact size of the apparatus, low loss and connection ease.

In consideration of these points, the object of the present invention is to provide an optical dispersion compensating element having superior group velocity delay time vs. wavelength characteristics and capable of performing adequate dispersion compensation, and particularly third order dispersion compensation, over a broad wavelength band that was unable to be realized practically in the prior art, that is compact, easy to use, has low loss, high reliability, in a state that is suitable for mass production, and at low cost. Moreover, another object of the present invention is to provide a dispersion compensating element and dispersion compensation method capable of third order dispersion compensation that use a multi-layer film element having a function that regulates the wavelength band and delay time of group velocity delay, or a dispersion compensating element and dispersion compensation method capable of performing both second order and third order dispersion compensation.

### DISCLOSURE OF INVENTION

The major characteristic of the compound dispersion compensating element that can be used in the dispersion compensation method of the present invention is the composing of a plurality of elements capable of performing third order dispersion compensation using a multi-layer film, or the composing of a plurality of portions of elements capable of performing dispersion compensation (the above elements capable of performing dispersion compensation and portions of elements capable of performing dispersion compensation will hereinafter be generally referred to as elements capable of performing dispersion compensation), by connecting in series with extremely low loss along the optical path of a signal light. The above compound dispersion compensating element can be formed so as to be able to compensate not only third order dispersion, but second order dispersion as well.

In addition to relating to a dispersion compensating element and compound dispersion compensating element that uses that element, the present invention also relates to a dispersion compensation method in which dispersion is compensated by composing a dispersion compensating element substantially equal to the above dispersion compensating element of the present invention. Thus, in the following explanation, the contents of the dispersion compensating element of the present invention are explained in the form of a dispersion compensating element used in the dispersion compensation method of the present invention, and also serves as an explanation of the dispersion compensation method.

One of the major characteristics of the dispersion compensating element, compound dispersion compensating element and dispersion compensating element used in the dispersion compensation method of the present invention is the alternating lamination of a reflective layer composed of a multi-layer film and a light transmitting layer, and using a multi-layer film element comprising at least three reflective layers and two light transmitting layers. Moreover, depending on the mode for carrying out the invention, another major characteristic of the present invention is being composed of at least two elements capable of performing dispersion compensation or at least two portions of an element capable of performing dispersion compensation (the above elements capable of performing dispersion compensation and portions of elements capable of performing dispersion compensation will hereinafter be generally referred to as elements capable of performing dispersion compensation), by connecting in series with extremely low loss along the optical path of a signal light, and as a result of having a dispersion compensating element using a multi-layer film (to be simply referred to as a multi-layer film element), another major characteristic of the present invention, depending on the mode by which it is carried out, is the composing of a compound dispersion compensating element in which dispersion compensating elements in the form of a chip or wafer are disposed in opposition to the incident surface of, for example, two dispersion compensating elements.

The above optical dispersion compensating element of the present invention comprising a multi-layer film can basically be applied to any wavelength band, and is capable of performing accurate dispersion compensation over the currently considered wavelength band of 1260-1700 nm as well as wavelength bands such as 1260-1360 nm, 1360-1460 nm, 1460-1530 nm, 1530-1565 nm, 1565-1625 nm, and 1625-1675 nm.

To achieve the object of the present invention, an example of the optical dispersion compensating element that can be used in the optical dispersion compensation method of the present invention is an optical dispersion compensating element characterized by being able to be used in optical communications using optical fiber for communication transmission path, which is capable of performing compensating dispersion in the form of wavelength dispersion; wherein the optical dispersion compensating element comprises at least one multi-layer film element capable of performing dispersion compensation, which comprises a multi-layer film comprising at least three reflective layers with mutually different optical reflectance and at least two light transmitting layers formed between the reflective layers, and is composed by optically connecting a plurality of elements capable of performing dispersion compensation in the form of the multi-layer film elements, or a plurality of locations of a portion of an element capable of performing dispersion compensation, in series along an optical path of signal light.

An example of the optical dispersion compensating element of the present invention is characterized in that there are a plurality of connection methods or connection paths of a plurality of elements capable of performing dispersion compensation.

An example of the optical dispersion compensating element of the present invention is characterized in that the connection method or connection path of a plurality of elements capable of performing dispersion compensation is selected from the outside of the optical dispersion compensating element.

An example of the optical dispersion compensating element of the present invention is characterized in that the connection method of a plurality of elements capable of performing dispersion compensation comprises a method according to reflection on incident surfaces of the multi-layer film elements disposed in mutual opposition.

An example of the optical dispersion compensating element of the present invention is characterized in that a means to select the connection methods or connection paths of the elements capable of performing dispersion compensation from the outside of the optical dispersion compensating element is an electrical means.

An example of the optical dispersion compensating element of the present invention is characterized in that the multi-layer film used in at least one of the elements capable of performing dispersion compensation constituting the optical dispersion compensating element is a multi-layer film in which the film thickness of each layer of the multi-layer film when considering as the optical path length relative to light of center wavelength λ of incident light is a film thickness of the value of about an integer multiple of λ/4, and the multi-layer film is composed with a plurality of sets of layers combining a layer H, which is a layer having a higher refractive index and a film thickness of about λ/4, and a layer L, which is a layer having a lower refractive index and a film thickness of about λ/4, and layer H is formed with a layer selected from the group consisting of Si, Ge, TiO₂, Ta₂O₅, and Nb₂O₅.

An example of the optical dispersion compensating element of the present invention is characterized in that at least one multi-layer film element is a multi-layer film element using a multi-layer film in which the film thickness of at least one laminated film constituting a multi-layer film varies in a direction within the laminated layer in a cross-section parallel to an incident surface of light of the multi-layer film, namely, in a direction within an incident surface.

An example of the optical dispersion compensating element of the present invention is characterized ii) that the layer L is formed by using the material having a lower refractive index than a refractive index of the material used in the layer H.

An example of the optical dispersion compensating element of the present invention is characterized in that the layer L is formed with a layer comprised of SiO₂.

An example of the optical dispersion compensating element of the present invention, is characterized in that a multi-layer film has two film thickness varying direction in which a film thickness varies in a direction within the incident surface.

An example of the optical dispersion compensating element of the present invention is characterized in that an adjustment means that adjusts the film thickness of at least one laminated film of the multi-layer film, or a means that varies the incident position of light in the incident surface of the multi-layer film, is provided by coupling to an optical dispersion compensating element.

In an example of the optical dispersion compensating element being used for the optical dispersion compensating element of the present invention, the multi-layer film element comprises at least one of multi-layer films A through H which will be described later.

Namely, an example of the optical dispersion compensating element of the present invention is characterized in that the optical dispersion compensating element comprises a multi-layer film comprising at least five kinds of laminated films with different optical properties (namely at least five layers of laminated films with different optical properties such as optical reflectance and film thickness), the multi-layer film comprising at least three kinds of reflective layers, including at least two kinds of reflective layers with mutually different optical reflectance, and at least two light transmitting layers in addition to the three kinds of reflective layers, each of the three types of reflective layers and each of the two light transmitting layers being alternately disposed, the multi-layer film being composed of a first layer in the form of a first reflective layer, a second layer in the form of a first light transmitting layer, a third layer in the form of a second reflective layer, a fourth layer in the form of a second light transmitting layer, and a fifth layer in the form of a third reflective layer, in that order from one side of the multi-layer film in the direction of film thickness, when the center wavelength of the incident light is defined as λ, the film thickness of each layer (that, hereinafter, is also simply referred to as film thickness or thickness of the film) constituting the multi-layer film in the first through fifth layers when the film thickness is defined as an optical path length relative to light of center wavelength λ of the incident light (that, hereinafter, is also simply referred to as an optical path length), being the film thickness of a value within the range of an integer multiple of λ/4±1% (which, hereinafter, is simply referred to as an integer multiple of λ/4 or about an integer multiple of λ/4), and the multi-layer film comprising a plurality of sets of layers combining a layer having a higher refractive index and a film thickness of λ/4 (which, hereinafter, is referred to as a layer H), and a layer having a lower refractive index and a film thickness of λ/4 (which, hereinafter, is referred to as a layer L); and
when multi-layer film A is taken to be a multi-layer film in) which five layers of laminated films, namely first through fifth layers, are respectively formed in order fiord one side in the direction of thickness of the multi-layer film) with a first layer composed by laminating three sets of HL layers in which one layer H and one layer L each are combined in order to make an HL layer, a second layer composed by laminating 10 sets of HH layers in which a layer H and a layer H are combined to make an HH layer, a third layer composed by laminating one layer L and seven sets of HL layers, a fourth layer composed by laminating 38 sets of HH layers, and a fifth layer composed by laminating one layer L and 13 sets of HL layers,
when multi-layer film B is taken to be a multi-layer film in which, in lieu of the second layer formed by laminating 10 sets of HH layers of multi-layer film A, the second layer is formed with a laminated film composed by laminating in order from one side in the direction of thickness of the film, which is the same direction as the case of multi-layer film A, three sets of HH layers, three sets of LL layers which combine a layer L and a layer L to make an LL layer, three sets of HH layers, two sets of LL layers and one set of NH layer in that order,
when multi-layer film C is taken to be a multi-layer film in which, in lieu of the fourth layer formed by laminating 38 sets of HH layers of multi-layer film A or multi-layer film B, the fourth layer is formed with a laminated film composed by laminating in order from one side in the direction of thickness of the film, which is the same direction as the case of multi-layer film A, three sets of HH layers, three sets of LL layers, three sets of HH layers, three sets of LL layers, three sets of HH layers, three sets of LL layers, three sets of HH layers, three sets of LL layers, three sets of HH layers, three sets of LL layers, three sets of HH layers, three sets of LL layers, three sets of HH layers and three sets of LL layers and two sets of HH layers in that order,
when multi-layer film D is taken to be a multi-layer film in which five layers of laminated films, namely first through fifth layers, are respectively formed in order from one side in the direction of thickness of the multi-layer film with a first layer composed by laminating five sets of LB layers in which one layer L and one layer H each are combined in that order to make an LH layer, a second layer composed by laminating seven sets of LL layers, a third layer composed by laminating one layer H and seven sets of LH layers, a fourth layer composed by laminating 57 sets of LL layers, and a fifth layer composed by laminating one layer H and 13 sets of LH layers,
when multi-layer film E is taken to be a multi-layer film in which five layers of laminated films, namely first through fifth layers, are respectively formed in order from one side in the direction of thickness of the multi-layer film with a first layer composed by laminating, two sets of HL layers, a second layer composed by laminating 14 sets of HH layers, a third layer composed by laminating one layer L and 6 sets of HL layers, a fourth layer composed by laminating 24 sets of HH layers, and a firth layer composed by laminating one layer L and 13 sets of HL layers,
when multi-layer film F is taken to be a multi-layer film in which, in lieu of the second layer formed by laminating 14 sets of HH layers of multi-layer film E, the second layer is formed with a laminated film composed by laminating in order from one side in the direction of thickness of the film, which is the same direction as the case of multi-layer film E, three sets of HH layers, three sets of LL layers, three sets of HH layers, three sets of LL layers, two sets of HH layers, one set of LL layer and one set of HH layer in that order,
when multi-layer film G is taken to be a multi-layer film in which, in lieu of the fourth layer formed by laminating 24 sets of HH layers of multi-layer film E or multi-layer film F, the fourth layer is formed with a laminated film composed by laminating in order form one side in the direction of thickness of the film, which is the same direction as the case of multi-layer film E, three sets of HH layers, three sets of LL layers, three sets of HH layers, three sets of LL layers, three sets of HH layers, three sets of LL layers, three sets of HH layers, three sets of LL layers, two sets of HH layers, one set of LL layer and one set of HH layer in that order, and
when multi-layer film H is taken to be a multi-layer film in which five layers of laminated films, namely, first through fifth layers, are respectively formed in order from one side in the direction of thickness of the multi-layer film with a first layer composed by laminating one layer L and four sets of LH layers, a second layer composed by laminating 9 sets of LL layers, a third layer composed by laminating one layer H and six sets of LH layers, a fourth layer composed by laminating 35 sets of LL layers, and a fifth layer composed by laminating one layer H and 13 sets of LH layers,
at least one multi-layer film element comprises at least one of multi-layer films A through H.

The major characteristic of the compound dispersion compensating element that can be used in the dispersion compensation method of the present invention is the composing of a plurality of elements capable of performing third order dispersion compensation using a multi-layer film, or the composing of a plurality of portions of elements capable of performing dispersion compensation (the above elements capable of performing dispersion compensation and portions of elements capable of performing dispersion compensation will hereinafter be generally referred to as elements capable of performing dispersion compensation), by connecting in series with extremely low loss along the optical path of a signal light. The above Compound dispersion compensating element can be formed so as to be able to compensate not only third order dispersion, but second order dispersion as well.

To achieve the object of the present invention, one of the major characteristic of the optical dispersion compensating element that can be used in the optical dispersion compensation method of the present invention is to have an element capable of performing dispersion compensation which is an element capable of performing dispersion compensation using group velocity delay time vs. wavelength characteristics of a multi-layer film. For performing the third order dispersion compensation, an example of the optical dispersion compensating element of the present invention is characterized in that the group velocity delay time vs. wavelength characteristics curve of the multi-layer film has at least one extreme value of the curve in the dispersion compensation target wavelength band, and a shape of the group velocity delay time vs. wavelength characteristics curve of the compound optical dispersion compensating element that can) be used in the optical dispersion compensation method of the present invention is sometimes different from a shape of the group velocity delay time vs. wavelength characteristics curve of an element capable of performing dispersion compensation which is comprised in the optical dispersion compensating element that can be used in the optical dispersion compensation method of the present invention.

The compound optical dispersion compensating element comprising above-mentioned multi-layer film, can basically be applied to any wavelength band. For example, the present invention is able to demonstrate extremely significant effects using a compound optical dispersion compensating element comprising multi-layer film having a group velocity delay time vs. wavelength characteristics curve having at least one extreme value in vile wavelength ranges of 1260-1700 nm which is widely noticed.

Furthermore, according to the present inventions it is able to compose a compound optical dispersion compensating element using the multi-layer films having a group velocity delay time vs. wavelength characteristics curve having at least one extreme value in the wavelength ranges of at least one band of O-band (1260-1360 nm), E-band (1360-1460 nm), S-bland (1460-1530 nm), C-band (1530-1565 nin), L-band (1565-1625 nm), and U-band (1625-1675 nm), or in the particular wavelength ranges of one wavelength band, and to perform accurate dispersion compensation in each communication wavelength band.

To achieve the object of the present invention, an example of a compound optical dispersion compensating element of the present invention is characterized in that a compound optical dispersion compensating element combining optical dispersion compensating elements that can be used in communications using optical fiber for communication transmission path, and can perform dispersion compensation in the form of wavelength dispersion; wherein at least a portion of optical dispersion compensating elements constituting the compound optical dispersion compensating element is composed such that at least one of at least a portion of an incident surface of a first optical dispersion compensating element and an incident surface of a second optical dispersion compensating element, which is different from the first optical dispersion compensating element disposed in oppositions and at least a portion of an incident surface of an optical dispersion compensating element selected from the first and second optical dispersion compensating elements and a reflective surface of a reflector referred to as reflector A below, disposed in opposition.

An example of the compound optical dispersion compensating element of the present invention is characterized in that, among those optical dispersion compensating elements constituting the compound optical dispersion compensating element, at least a pair of the incident surface of a first optical dispersion compensating element and the incident surface of a second optical dispersion compensating element disposed in mutual opposition, or at least a pair of the incident surface of an optical dispersion compensating element and the reflective surface of reflector A disposed in mutual opposition, are disposed in close proximity to enable the entrance and reflection of incident light to the optical dispersion compensating element to be performed a plurality of times between the incident surface of the first optical dispersion compensating element and the incident surface of the second optical dispersion compensating element disposed in mutual opposition, or between the incident surface of the optical dispersion compensating element and the reflective surface of the reflector A disposed in mutual opposition.

To achieve the object of the present invention, each example of the compound optical dispersion compensating element of the present invention has several characteristics respectively. Some examples of the above characteristics are as follows.

An example of the compound optical dispersion compensating element of the present invention is characterized in that there are a plurality of connection methods or connection paths of the plurality of elements capable of performing dispersion compensation.

An example of the compound optical dispersion compensating element of the present invention is characterized by allowing to select the connecting methods and paths of the elements capable of performing dispersion compensation from the outside of the optical dispersion compensating element.

An example of the compound optical dispersion compensating element of the present invention is characterized in that one of the means to select the connecting methods and paths of the elements capable of performing dispersion compensation from the outside of the optical dispersion compensating element is an electrical means.

An example of the compound optical dispersion compensating element of the present invention is characterized in that at least a portion of the optical dispersion compensating elements constituting the compound optical dispersion compensating element are optical dispersion compensating elements comprising a so-called multi-layer film element comprising a multi-layer film capable of performing dispersion compensation.

An example of the compound optical dispersion compensating element of the present invention is characterized in that the optical dispersion compensating element, in which at least a portion of the incident surface of light of the first optical dispersion compensating element constituting the compound optical dispersion compensating element is disposed in opposition to the incident surface of a second optical dispersion compensating element different from a first optical dispersion compensating element, or the reflective surface of the reflector A, is an optical dispersion compensating element comprising a multi-layer film element using multi-layer film capable of performing dispersion compensation.

An example of the compound optical dispersion compensating element of the present invention is characterized in that at least one of the incident surface of the second optical dispersion compensating element disposed in opposition to the incident surface of signal light of the first optical dispersion compensating element and the reflective surface of the reflector A disposed in opposition to the incident surface of signal light of the optical dispersion compensating element wherein the first and second optical dispersion compensating elements and/or the optical dispersion compensating element and the reflector A constitute the compound optical dispersion compensating element, is flat.

An example of the compound optical dispersion compensating element of the present invention is characterized in that at least one of the incident surface of the second optical dispersion compensating element disposed in opposition to the incident surface of signal light of the first dispersion compensating element and the reflective surface of the reflector A disposed in opposition to the incident surface of signal light of the first dispersion compensating elements wherein the first and second optical dispersion compensating elements and/or the optical dispersion compensating element and the reflector A constitute the compound optical dispersion compensating element, is curved.

An example of the compound optical dispersion compensating element of the present invention is characterized in that the multi-layer film element constituting at least one of the optical dispersion compensating elements has a multi-layer film comprising at least three light reflecting layers also referred to as reflective layers and at least two light transmitting layers, and is formed such that each light transmitting layer is interposed between two of the reflective layers; and the multi-layer film has at least one reflective layer in which the reflectance relative to center wavelength λ of incident light is 99.7% or more, and the reflectance of each reflective layer disposed from the incident surface to the position of the first reflective layer having reflectance of 99.7% or more appearing first in the direction of thickness of the multi-layer film gradually becomes larger from the side of the incident surface in the direction of thickness of the multi-layer film.

An example of the compound optical dispersion compensating element of the present invention is characterized in that a reflector or reflecting portion, also referred to as reflector B, which is different from the reflector A, is provided in opposition to or in the vicinity of at least a portion of optical dispersion compensating elements composed such that at least one of at least a portion of an incident Surface of a first optical dispersion compensating element and an incident surface of a second optical dispersion compensating element, which is different from the first optical dispersion compensating element, disposed in opposition, and at least a portion of an incident surface of an optical dispersion compensating element selected from the first and second optical dispersion compensating elements and a reflective surface of the reflector A, disposed in opposition, wherein the first and second optical dispersion compensating elements and/or the optical dispersion compensating element and the reflector A constitute the compound optical dispersion compensating element.

An example of the compound optical dispersion compensating element of the present invention is characterized in that the reflector B is disposed so as to reflect light referred to as light A emitted from any one of the pair of optical dispersion compensating elements in which incident surfaces thereof are disposed in mutual opposition, or emitted from any one of the reflective surface of an optical dispersion compensating element and reflector A arranged in opposition, and allow the light to enter the optical dispersion compensating element or reflector A.

An example of the compound optical dispersion compensating element of the present invention is characterized in that a location where light A enters as light referred to as light B reflected by reflector B is the optical dispersion compensating element or reflector A from which light A is emitted.

An example of the compound optical dispersion compensating element of the present invention is characterized in that the outgoing position of light A and the incident position of light B in the optical dispersion compensating element are different positions.

An example of the compound optical dispersion compensating element of the present invention is characterized in that light A and light B travel in parallel and in opposite directions.

An example of the compound optical dispersion compensating element of the present invention is characterized in that reflector B has at least three reflective surfaces.

An example of the compound optical dispersion compensating element of the present invention is characterized in that at least one of the reflective surfaces of reflector B is movable.

An example of the compound optical dispersion compensating element of the present invention is characterized in that one of the means to drive the movable reflective surface of reflector B is a manual means or an electrical means.

An example of the compound optical dispersion compensating element of the present invention is characterized in that at least one pair of reflecting portions are provided on the same side of the end of, or in the vicinity of the same side of the end of a pair of optical dispersion compensating elements in which the incident surfaces are disposed in opposition, or an optical dispersion compensating element and reflector A disposed in opposition, or a pair of reflectors B are provided integrated into a single unit with at least one of a pair of optical dispersion compensating elements in which the incident surfaces thereof are disposed in opposition, or with at least one of an optical dispersion compensating element and reflector A disposed in opposition, so as to reflect either emitted light from any one of a pair of optical dispersion compensating elements in which the incident surfaces are disposed in opposition and each optical dispersion compensating element is also referred to as an optical dispersion compensating element unit, or emitted light from any one of the reflector A and optical dispersion compensating element disposed in opposition.

An example of the compound optical dispersion compensating element of the present invention is characterized in that reflector B is a corner cube.

An example of the compound optical dispersion compensating element of the present invention is characterized in that the traveling direction of light B after entering either of a pair of optical dispersion compensating elements in which the incident surfaces are disposed in oppositions or after entering either an optical dispersion compensating element or reflector A disposed in opposition, is parallel and opposite to the traveling direction of light A which has traveled over the optical dispersion compensating element prior to being emitted.

An example of the compound optical dispersion compensating element of the present invention is characterized in that reflector B is provided corresponding to a plurality of locations of the ends of, or in the vicinity of the ends of a pair of optical dispersion compensating elements in which the incident surfaces are disposed in opposition, of the ends of or in the vicinity of the end of an optical dispersion compensating element and reflector A disposed in opposition.

An example of the compound optical dispersion compensating element of the present invention is characterized in that the traveling direction of signal light which travels while being subjected to dispersion compensation by entering the incident surface of each optical dispersion compensating element unit of a pair of optical dispersion compensating element units in which the incident surfaces are disposed in opposition is sequentially and alternately opposite at positions moving from one side of the incident surface to the other side of the incident surface, or by entering the incident surface of an optical dispersion compensating element disposed in opposition to reflector A, is sequentially and alternately opposite at positions moving from one side of the incident surface to the other side of the reflector A.

An example of the compound optical dispersion compensating element of the present invention is characterized in that each optical dispersion compensating element unit of a pair of optical dispersion compensating elements in which the incident surfaces are disposed in opposition comprises a multi-layer film element formed on respectively different substrates.

All example of the compound optical dispersion compensating element of the present invention is characterized in that the multi-layer film of each optical dispersion compensating element unlit of at least a pair of optical dispersion compensating elements in which the incident surfaces are disposed in opposition is formed on mutually opposing surfaces of the same substrate through which incident light is transmitted so that the incident surface of the optical dispersion compensating element unit is on the substrate side.

An example of the compound optical dispersion compensating element of the present invention is characterized in that reflectances of at least three reflective layers from a substrate side of a multi-layer film constituting an optical dispersion compensating element or at least one optical dispersion compensating element unit becomes larger moving from the reflective layer nearest the substrate to the reflective layer farthest from the substrate.

An example of the compound optical dispersion compensating element of the present invention is characterized in that an incident position and outgoing position of signal light on a pair of optical dispersion compensating elements in which at least one set of incident surfaces is disposed in opposition, or signal light on a pair of an optical dispersion compensating element and the reflective surface of reflector A disposed in oppositions are on mutually different sides of a pair of optical dispersion compensating elements in which the incident surfaces are disposed in opposition, or a pair of an optical dispersion compensating element and reflector A disposed in mutual opposition.

An example of the compound optical dispersion compensating element of the present invention is characterized in that an incident position and outgoing position of signal light on at least one pair of optical dispersion compensating elements in which the incident surfaces are disposed in opposition, or signal light on a pair of an optical dispersion compensating element and the reflective surface of reflector A disposed in opposition, are on the same sides of a pair of optical dispersion compensating elements in which the incident surfaces are disposed in opposition, or a pair of an optical dispersion compensating element and reflector A disposed in opposition.

All example of the compound optical dispersion compensating element of the present invention is characterized in that at least one multi-layer film element comprises a multi-layer film being constituted at least five kinds of laminated films with different optical properties, namely, at least five layers of laminated films with different optical properties such as optical reflectance and film thickness, the multi-layer film being constituted at least three kinds of reflective layers, including at least two kinds of reflective layers with mutually different optical reflectance, and at least two light transmitting layers in addition to the three types of reflective layers each of the three types of reflective layers and each of the two light transmitting layers being alternately disposed, the multi-layer film being composed of a first layer in the form of a first reflective layer, a second layer in the form of a first light transmitting layer, a third layer in the form of a second reflective layer, a fourth layer in the form of a second light transmitting layer, and a fifth layer in the form of a third reflective layer, in that order from one side in the direction of film thickness, when the center wavelength of the incident light is defined as λ, the film thickness of each layer composing the multi-layer film in the first through fifth layers when the film-n thickness is defined as an optical path length relative to light of center wavelength λ of the incident light, being the film thickness of a value within the range of about an integer multiple of λ/4±1%, and the multi-layer film being composed with a plurality of sets of layers combining a layer H, which is a layer having a higher refractive index and a film thickness of about λ/4±1%, and a layer L, which is a layer having a lower refractive index and a film thickness of about λ/4±1%, and at least one multi-layer film element, in concretely, is able to have at least one of above-mentioned multi-layer films A through H or many kind of multi-layer films concluded from the explanation of the present invention.

An example of the compound optical dispersion compensating element of the present invention is characterized in that the film thickness of at least one laminated film constituting a multi-layer film of at least one optical dispersion compensating element varies in a direction within the laminated layer in a cross-section parallel to the incident surface of light of the multi-layer film, namely, in a direction within the incident surface, or in other words, a film thickness varies according to a position within the laminated film.

An example of the compound optical dispersion compensating element of the present invention is characterized in that each direction in which film thickness of at least one of light transmitting, layers of the multi-layer film of at least one of each optical dispersion compensating element unit of optical dispersion compensating elements constituting the compound optical dispersion compensating element, in which at least a pair of incident surfaces are disposed in mutual opposition, varies in a direction within the incident surface and each direction in which film thickness varies is mutually different.

An example of the compound optical dispersion compensating element of the present invention is characterized in that the film thickness of at least one of each of light transmitting layers of the multi-layer film of each optical dispersion compensating element unit of optical dispersion compensating elements constituting the compound optical dispersion compensating element, in which at least a pair of incident surfaces are disposed in mutual opposition, varies in mutually opposite directions.

An example of the compound optical dispersion compensating element of the present invention is characterized in that an adjustment means which adjusts the film thickness of at least one laminated film of the multi-layer film, or a means which varies the incident position of light in the incident surface of the multi-layer film, is provided by coupling to an optical dispersion compensating element.

An example of the compound optical dispersion compensating element of the present invention is characterized in that at least one of the multi-layer film elements is an optical dispersion compensating element capable of compensating primarily the third order dispersion.

An example of the compound optical dispersion compensating element of the present invention is characterized in that at least one of the optical dispersion compensating elements is an optical dispersion compensating element capable of compensating the second order dispersion.

Furthermore, to achieve the object of the present invention, the optical dispersion compensation method of the present invention is characterized by compensating the dispersion of the signal light by using the compound optical dispersion compensating element having above-mentioned some characteristics or by using essentially equivalent optical dispersion compensating element composed by using obtained optical dispersion compensating elements as several parts.

The optical dispersion compensation method of the present invention is characterized in that an optical dispersion compensation method for performing dispersion compensation using an optical dispersion compensating element comprising a multi-layer film capable of performing dispersion compensation in the form of wavelength dispersion in optical communication using an optical fiber for a communication transmission path, comprising a step of allowing incident light to pass along an optical path to perform dispersion compensation of incident light by: disposing at least one of at least a portion of an incident surface of light entering a first optical dispersion compensating element and an incident surface of a second optical dispersion compensating element, which is different from the first optical dispersion compensating element, in mutual opposition, and at least a portion of an incident surface of light entering an optical dispersion compensating element selected from the first and second optical dispersion compensating elements and a reflective surface of a reflector referred to as a reflector A, in mutual opposition, disposing the incident surfaces of the first add second optical dispersion compensating elements, in mutual opposition, and/or the incident surface of the optical dispersion compensating element selected from the first and second optical dispersion compensating elements and the reflective surface of the reflector A, in mutual opposition, to form the optical path of incident light therebetween; and constituting a composite optical dispersion compensating element comprising at least a pair of optical dispersion compensating elements in which entrance and reflection of incident light, which has entered between both the incident surfaces or the incident surface and the reflective surface disposed in opposition, on the incident surface of the optical dispersion compensating elements while traveling along the optical path is performed a plurality of times.

An example of the optical dispersion compensation method of the present invention is characterized in that dispersion compensation of incident light is performed by disposing a reflector or reflecting portion to be referred to as reflector B corresponding to at least to a portion or the vicinity of at least one set of a pair of optical dispersion compensating elements disposed in opposition or an optical dispersion compensating element and reflector A disposed in opposition.

An example of the optical dispersion compensation method of the present invention is characterized in that dispersion compensation of incident light is performed by disposing reflector B so as to be able to reflect light referred to as light A emitted from either of a pair of optical dispersion compensating elements disposed in opposition, or emitted from any of an optical dispersion compensating element and reflector A disposed in Opposition each other, and allow the light A to enter an optical dispersion compensating element.

An example of the optical dispersion compensation method of the present invention is characterized in that dispersion compensation of incident light is performed by disposing the optical dispersion compensating elements and reflectors so that light reflected by reflector B to also be referred to as light B again enters the optical dispersion compensating element from which light A was emitted.

An example of the optical dispersion compensation method of the present invention is characterized in that the outgoing position of light A and the incident position of light B in an optical dispersion compensating element are different positions.

An example of the optical dispersion compensation method of the present invention is characterized in that light A and light B travel in parallel but in opposite directions.

An example of the optical dispersion compensation method of the present invention is characterized in that light reflector B being used for the optical dispersion compensation of the present invention has at least three reflective surfaces.

An example of the optical dispersion compensation method of the present invention is characterized in that the film thickness of at least one laminated film constituting at least one of the multi-layer film varies in a direction within the surface in a cross-section parallel to the incident surface.

An example of the optical dispersion compensation method of the present invention is characterized in that the optical dispersion compensating element composed by connecting in series a plurality of elements capable of performing dispersion compensation is composed so as to have a group velocity delay time vs. wavelength characteristics curve having at least one extreme value in at least one wavelength range of wavelength ranges of 1260-1360 nm, 1360-1460 nm, 1460-1530 nm, 1530-1565 nm, 1565-1625 nm, and 1625-1675 mm.

An example of the optical dispersion compensation method of the present invention is characterized by allowing the selection of a plurality of ways to connect elements capable of performing dispersion compensation in the optical path of signal light.

An example of the optical dispersion compensation method of the present invention is an optical dispersion compensation method characterized by the dispersion compensation of a signal light being dispersion compensation capable of performing at least the third order dispersion compensation.

Although the above has provided an explanation of the characteristics of the present invention, the optical dispersion compensating element, compound optical dispersion compensating element that uses that element and optical dispersion compensation method that uses that element of the present invention demonstrate considerable effects in ultra-high-speed optical communications of, for example, 40 Gbps or 80 Gbps to be described later by either suitably combining each of the inventions having the various characteristics as described above or using each of the inventions alone.

### BRIEF DESCRIPTION OF DRAWINGS

FIG. 1 is a drawing explaining the optical dispersion compensation according to the present invention.

FIG. 2 is a cross-sectional view for explaining the multi-layer film used in the present invention.

FIG. 3 is a perspective view for explaining the multi-layer film used in the present invention.

FIG. 4 shows group velocity delay time vs. wavelength characteristics curves of the multi-layer film used in the present invention.

FIG. 5A is a graph representing the group velocity delay time vs. wavelength characteristics of a single element capable of performing dispersion compensation that serves as the basis of the dispersion compensating element of the present invention.

FIG. 5B is a graph that explains a method for improving group velocity delay time vs. wavelength characteristics using a plurality of elements capable of performing dispersion compensation of the present invention, and represents the group velocity delay time vs. wavelength characteristics of the optical dispersion compensating element or the present invention in which two elements capable of performing dispersion compensation are connected in series.

FIG. 5C is a graph that explains a method for improving group velocity delay time vs. wavelength characteristics using a plurality of elements capable of performing dispersion compensation of the present invention, and represents the group velocity delay time vs. wavelength characteristics of the optical dispersion compensating element of the present invention in which three elements capable of performing dispersion compensation are connected in series.

FIG. 5D is a graph that explains a method for improving group velocity delay time vs. wavelength characteristics using a plurality of elements capable of performing dispersion compensation of the present invention, and represents the group velocity delay time vs. wavelength characteristics of the optical dispersion compensating element of the present invention in which three elements capable of performing dispersion compensation are connected in series.

FIG. 6A is a drawing that explains the connection of optical dispersion compensating elements, and explains an example of composing an optical dispersion compensating element by connecting two elements capable of performing dispersion compensation in series.

FIG. 6B is a drawing that explains the connection of optical dispersion compensating elements, and explains an example of composing an optical dispersion compensating element by connecting three elements capable of performing dispersion compensation in series.

FIG. 6C is a drawing that explains the connection of optical dispersion compensating elements and explains an example of composing an optical dispersion compensating element by connecting two incident positions of a signal light in series along the path of a signal light on a multi-layer film in which film thickness varies in a direction within the incident surface.

FIG. 6D is a drawing that explains an example of a optical dispersion compensating element in which optical dispersion compensating elements are mounted in a single case.

FIG. 7A is a perspective view that explains a compound optical dispersion compensating element of the present invention.

FIG. 7B is a drawing that explains a compound optical dispersion compensating element of the present invention as viewed from above.

FIG. 8 is a drawing that explains another example of a compound optical dispersion compensating element of the present invention.

FIG. 9 is a drawing that explains the croup velocity delay time vs. wavelength characteristics curve of the compound optical dispersion compensating element of FIG. 7A.

FIG. 10A is cross-sectional view that explains a pair of optical dispersion compensating elements 900 disposed in opposition to an incident surface that is one of the constituent elements of the compound optical dispersion compensating element of the present invention.

FIG. 10B is a drawing of compound optical dispersion compensating element 900 of the present invention as viewed from the direction of arrow 941 of FIG. 10A.

FIG. 11 is a drawing showing a corner cube.

FIG. 12A is an overhead view showing a mode for carrying out the present invention.

FIG. 12B is a front view showing one mode for carrying out FIG. 12A.

FIG. 13A is a drawing for explaining a compensation method of second order and third order wavelength dispersion that explains the wavelength vs. time characteristics and optical intensity vs. time characteristics.

FIG. 13B is a drawing for explaining a compensation method of second order and third order wavelength dispersion that explains the transmission path.

FIG. 13C is a drawing for explaining a compensation method of second order and third order dispersion that explains the transmission path.

FIG. 14 is a graph showing the dispersion vs. wavelength characteristics of an optical fiber of the prior art.

### BEST MODE FOR CARRYING OUT THE INVENTION

The following provides an explanation of a mode for carrying out the present invention with reference to the drawings. Furthermore, although each of the drawings used in the explanation schematically show the dimensions, shape and layout relationship of each constituent component to a degree that enables the present invention to be understood, for the sake of convenience in providing the explanation, those components may be illustrated while partially changing the enlargement factor, and there are cases in which they may not always resemble the actual objects or descriptions of the embodiments and so forth. In addition, in each of the drawings, similar constituent components are indicated by assigning the same reference symbols, and duplicate explanations may be omitted.

FIG. 1 is a drawing that explains a method for compensating dispersion occurring in communications using an optical fiber for the transmission path with an optical dispersion compensating element. Reference symbol 1101 indicates a group velocity delay time vs. wavelength characteristics curve indicating third order dispersion of a signal light that remains following compensation of second order dispersion, reference symbol 1102 indicates a group velocity delay time vs. wavelength characteristics curve of a dispersion compensating element, and reference symbol 1103 indicates a group velocity delay time vs. wavelength characteristics curve between compensation target wavelength band λ₁-λ₂ after dispersion of signal light having the dispersion characteristics of curve 1101 has been compensated with a dispersion compensating element having the dispersion characteristics of curve 1102, with group velocity delay time plotted on the vertical axis and wavelength plotted on the horizontal axis.

In the present invention, an element capable of performing dispersion compensation itself as well as that composed of the element are broadly referred to an optical dispersion compensating element, and because of the need in terms of the explanation, each element constituting the compound optical dispersion compensating element of the present invention, for example, may be referred to as an optical dispersion compensating element, and each of the optical dispersion compensating element units disposed in opposition to an incident surface, and when no particular distinction is required, the optical dispersion compensating element unit, may also be referred to as an optical dispersion compensating element. In particular, when it is necessary to make a distinction in describing each of the above optical dispersion compensating elements in which the incident surfaces are disposed in opposition, it may also be referred to as all optical dispersion compensating element unit. As will be described later, in the case of, for example, explaining or describing an element itself that is capable of performing dispersion compensation as a constituent element in the case of an optical dispersion compensating element being composed of a plurality of elements capable of performing dispersion compensation, it will be referred to as an element that is capable of performing dispersion compensation. In addition when referring to a portion of a multi-layer film capable of performing dispersion compensation that is formed on the same wafer of chip, that portion will be referred to as a portion of an, element capable of performing dispersion compensation.

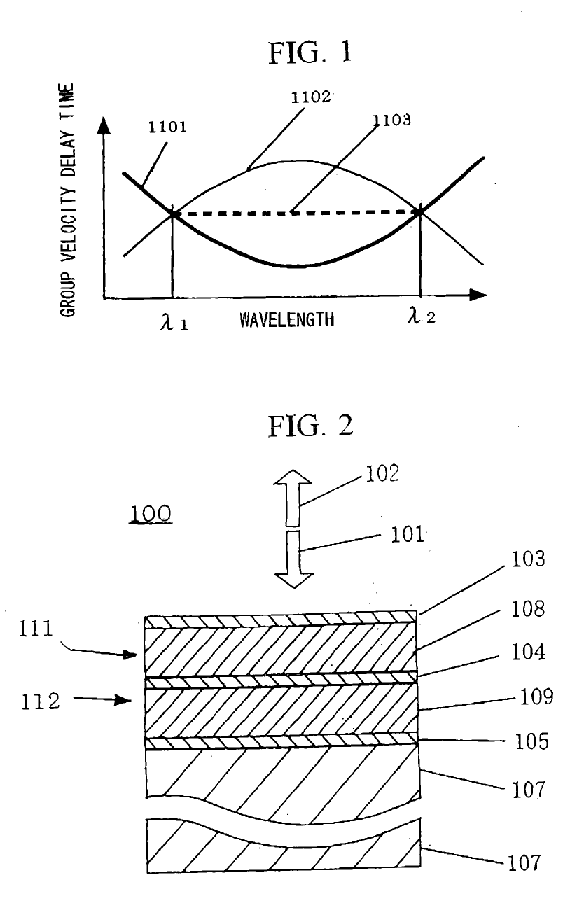

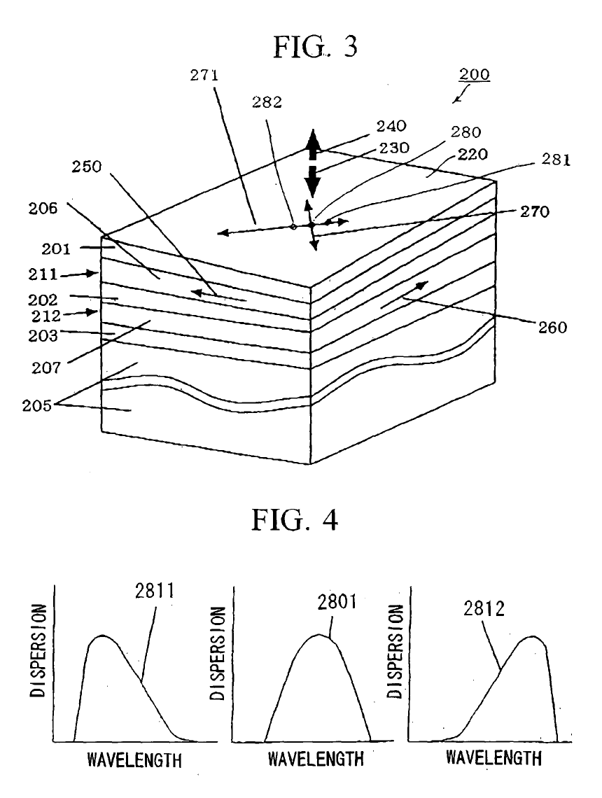

FIGS. 2 through 4 are drawings that explain an example of an element capable of performing dispersion compensation constituting each optical dispersion compensating clement used in the present invention. FIG. 2 is a cross-sectional view of a multi-layer film to be described later. FIG. 3 is a perspective view of a multi-layer film in which the film thickness has been varied, and FIG. 4 is an example of a group velocity time delay vs. wavelength characteristics curve of a multi-layer film.

FIG. 2 is a drawing that provides a schematic explanation of the cross-section of a multi-layer film used as an example of a third order optical dispersion compensating element used in the present invention. In FIG. 2, reference symbol 100 indicates a multi-layer film as an example of an optical dispersion compensating element used in the present invention, reference symbol 101 indicates an arrow showing the direction of incident light, reference symbol 102 indicates an arrow showing the direction of outgoing light, reference symbols 103 and 104 indicate reflective layers having reflectance of less than 100% (hereinafter to also be referred to as reflective films or light reflecting layers), reference symbol 105 indicates a reflective layer having reflectance of 98-100%, reference symbols 108 and 109 indicate light transmitting layers (hereinafter to also be referred to as simply transmitting layers), reference symbols 111 and 112 indicate cavities in the form of a concept used for convenience in the explanation (and the term cavity is to be used with the same meaning hereinafter) of the correlation between the transmitting layers at the locations of the arrows and the reflective layers located above and below them. In addition, reference symbol 107 indicates a substrate that uses, for example, BK-7 glass (trade name, manufactured by Schott AG, Germany).

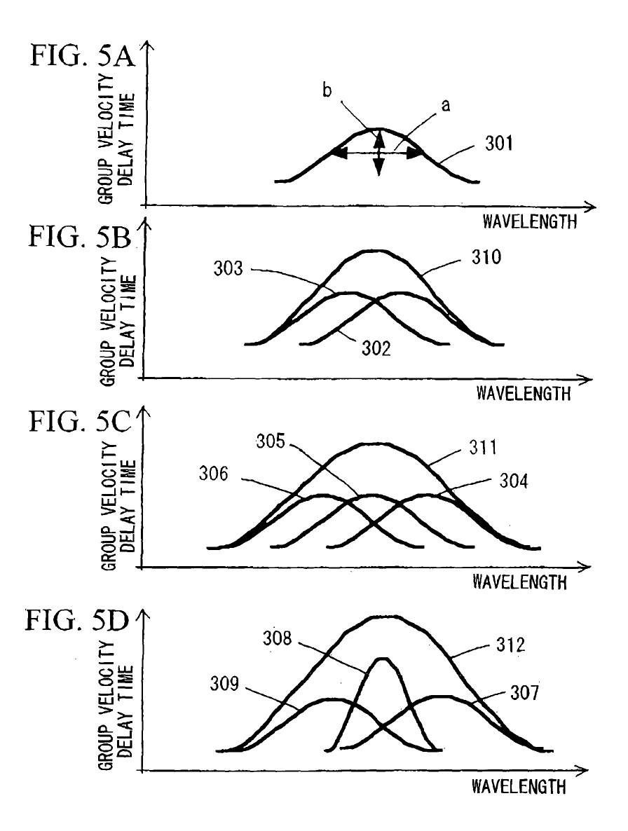

Reflectance R(103), R(104), and R(105) of each reflective layer 103, 104 and 105 of FIG. 2 has the relationship of R(103)≦R(104)≦R(105). It is preferable in terms of mass production that the reflectance of each reflective layer be set so that it is mutually different at least between adjacent reflective layers between which a light transmitting layer is provided, Namely, each reflective layer is formed so that the reflectance of each reflective layer relative to the center wavelength 1 of the incident light (hereinafter to be simply be referred to as wavelength 1 when providing an explanation relating to film thickness of the multi-layer film) gradually becomes larger from the side oil which incident light enters towards the direction of thickness of the multi-layer film. Particularly preferably, by composing so that reflectance relative to light of the above wavelength 1 of each reflective layer is within the range of 60%≦R(103)≦77%, 96%≦R(104)≦99.8%, and 98%≦R(105), and satisfies the above magnitude relationship of R(103), R(104) and R(105), a group velocity delay time vs. wavelength characteristic curve can be obtained as shown in FIG. 4 and FIGS. 5A through 5D. By more preferably making R(103)<R(104)<R(105), and even more preferably, making R(105) close to 100% or 100%, the performance of the optical dispersion compensating element used in the present invention can be further enhanced.

In order to more greatly facilitate production of the optical dispersion compensating element used in the present in invention, a third order optical dispersion compensating element having high reliability and excellent mass productivity can be provided at low cost in which the forming conditions of each reflective layer are preferably selected so that the interval when considered as the path length between each adjacent reflective layer is respectively different, the design conditions of the reflectance of each reflective layer can be relaxed, and the multi-layer film used in the third order optical dispersion compensating element used in the present invention can be formed with a combination of unit films having a film thickness of one-fourth wavelength 1 (namely, films having a film thickness that is an integral multiple of λ/4).

Furthermore, although the film thickness of the unit film of the above multi-layer film has been described as being one-fourth wavelength 1, this refers to λ/4 within the range of error allowed by film formation in mass production, and in consideration of the current level of multi-layer film forming technology, typically refers to a film thickness of λ/4 as referred to in the present invention in terms of λ/4±1%, and the present invention demonstrates particularly significant effects in tis range. However, since a multi-layer film can be produced that allows the obtaining of the group velocity delay time vs. wavelength characteristics curve described later in terms of the overall multi-layer film even if there are films present having error slightly larger than λ/4±1%, such a multi-layer film can be referred to as a “multi-layer film in which unit films having a film thickness of one-fourth wavelength 1 are laminated” as referred to in the present invention. In particular, by making the above thickness of the unit films λ/4±0.5% (λ/4 in this case indicates λ/4 in the absence of error), a multi-layer film can be formed that does not impair mass productivity, has low variation and high reliability, and allows the optical dispersion compensating element to be described later to be provided at low cost.

In addition, in the present invention, the formation of a multi-layer film has been explained as laminating unit films having a film thickness of λ/4, and although a multi-layer film can be formed by repeating a process of forming one unit film and then forming the next unit film, formation of a multi-layer film is not limited to this process, but rather films having a film thickness of an integral value of λ/4 are typically formed continuously, and this type of multi-layer film is naturally also included in the multi-layer film of the present invention.

In actuality, several examples of the multi-layer film of the present invention have been able to be formed using a film formation process in which the above reflective layer and light transmitting layer are formed continuously.

FIG. 3 is a drawing that explains an example of changing the film thickness of the above multi-layer film in the direction within a plane parallel to incident surface 220 to be described later of multi-layer film 100 in FIG. 1.

In FIG. 3, reference symbol 200 indicates a multi-layer film as an example of the optical dispersion compensating element used in the present invention, reference symbol 201 indicates a first reflective layer, reference symbol 202 indicates a second reflective layer, reference symbol 203 indicates a third reflective layer, reference symbol 205 indicates a substrate, reference symbol 206 indicates a first light transmitting layer, reference symbol 207 indicates a second light transmitting layer, reference symbol 211 indicates a first cavity, reference symbol 212 indicates a second cavity, reference symbol 220 indicates a light incident surface, reference symbol 230 indicates an arrow showing the direction of incident light, reference symbol 240 indicates an arrow showing the direction of outgoing light, reference symbol 250 indicates an arrow showing the direction of a first variation in film thickness, reference symbol indicates an arrow showing a second variation in film thickness, and reference symbols 270 and 271 indicate arrows showing the directions of movement of the incident position of the incident light.

In FIG. 3, for example, third reflective layer 203, second light transmitting layer 207, second reflective layer 202, first light transmitting layer 206 and first reflective layer 201 are sequentially formed on substrate 205 using BK-7 glass.

Multi-layer film 200 is formed so that the thickness of first light transmitting layer 206 varies in the direction shown with arrow 250 of FIG. 3 (gradually becoming thicker from right to left in the figure), and so that the thickness of second light transmitting layer 207 varies in the direction shown with arrow 260 (gradually becoming thicker from the front to the back in the figure). The thicknesses of the first to third reflective layers are formed so as to be composed such that the reflectance of each of the first, second, and third reflective layers satisfies the conditions complying with large and small relationship of the above R(103), R(104) and R(105), namely R(201)≦R(202)≦R(203) and the like when the reflectances of reflective layers 201, 202, and 203 are taken to be R(201), R(202), and R(203), respectively, when the wavelength when the first and second cavity resonance wavelengths coincide has coincided with the center wavelength 1 of the incident light.

FIG. 4 provides an explanation of a situation in which the group velocity delay time vs. wavelength characteristics curve varies when the incident position of incident light has moved in the direction of arrow 270 or arrow 271 of FIG. 3 as described later so as to allow incident light to enter from the direction of arrow 230 of FIG. 3 and obtain outgoing light in the direction of arrow 240 in incident surface 220 of multi-layer film (to simply be referred to as an optical dispersion compensating element) 200 as an example of the optical dispersion compensating element of the present invention.

FIG. 4 indicates the group velocity delay time vs. wavelength characteristics curves when incident light of center wavelength 1 has entered at incident positions 280 through 282 of FIG. 3, with group velocity delay time plotted on the vertical axis and wavelength plotted on the horizontal axis.

By suitably selecting the conditions by which film thickness varies in the directions of arrows 250 and 260 of reflective layers 201-203 and light transmitting layers 206 and 207 of FIG. 3, namely the directions roughly parallel to the incident surface (also referred to as directions within the incident surface in the present invention), band center wavelength λ₀ of the group velocity delay time vs. wavelength characteristics curve (for example, the wavelength that imparts an extreme value in group velocity delay time vs. wavelength characteristics curve 2801 having a roughly laterally symmetrical shape of FIG. 4) varies while maintaining the shape of the group velocity delay time vs. wavelength characteristics curve in nearly the same shape, and when the above incident position is moved from that position in the direction indicated with arrow 271, the above wavelength λ₀ hardly varies at all, while the shape of the group velocity delay time vs. wavelength characteristics curve can be varied in the manner of curves 2811 and 2812 of FIG. 4.

Although band center wavelength λ₀ in curves 2801, 2811, and 2812 of FIG. 4 is set to, for example, the location of a suitable wavelength in the graphs of FIG. 4 according to the objective of dispersion compensation, it may also be, for example, nearly the central value of the wavelength range of the curves shown in FIG. 4, and may be suitably determined according to the objective of dispersion compensation. Furthermore in practical terms, the wavelength of each characteristic point, such as each extreme value wavelength from curve 2801 to curve 2812, curve 2801 to curve 2811, and curve 2811 to curve 2812, curve shape and other corresponding relationships should be investigated in advance and be reflected in selection of incident position.

In this manner, by, for example, first moving and determining the incident position of incident light in the direction of arrow 270 of FIG. 3 so as to align the band center wavelength λ₀ of the dispersion compensating element with the center wavelength 1 of the incident light to be compensated for dispersion, selecting the shape of the group velocity delay time vs. wavelength characteristics curve used for dispersion compensation by conforming to the ensured contents to be compensated for dispersion, namely the dispersion status of the incident light, and selecting the above incident position in the direction shown in arrow 271 of FIG. 3 in the manner of, for example, each of the points indicated with reference symbols 280-282, dispersion compensation required by the signal light can be performed effectively.

As is also clear from the shape of the group velocity delay time vs. wavelength characteristics curves of FIG. 4, third order dispersion compensation can be performed using, for example, curve 2801 by using the optical dispersion compensating element of the present invention, and trace second order dispersion compensation can be performed using a portion near the comparatively linear portion of curve 2811 or curve 2812.

Although the above explanation using FIGS. 2 through 4 has focused on “an element capable of performing optical dispersion compensation that is a portion of a dispersion compensating element” used in the present invention, the use of this “element capable of performing dispersion compensation” makes it possible to compensate third order dispersion in a certain wavelength band.

However, although it is comparatively easy to make the wavelength bandwidth of dispersion compensation that can be compensated with the “element capable of performing dispersion compensation” alone about 1.5 nm and the group velocity delay time about 3 ps (picoseconds) for signal light of a wavelength around 1.55 mm, when an attempt is made to widen the wavelength bandwidth of dispersion compensation in order to be compatible with multi-channel optical communications, it is difficult to obtain group velocity delay time of a degree that allows dispersion compensation to be performed adequately, and further improvements are desired for Greater ease of use and broader use of actual communications, Therefore, a more detailed explanation is provided of the present invention using FIGS. 5A through 5D, FIGS. 6A through 6D, and FIGS. 7 through 10.

FIGS. 5A through 5D provide an explanation of a method for improving the group velocity delay time vs. wavelength characteristics using a plurality of elements capable of performing dispersion compensation that use a multi-layer film as explained in FIGS. 2 through 4. FIG. 5A is a graph of the group velocity delay time vs. wavelength characteristics of a single element capable of performing dispersion compensation used in the present invention. FIG. 5B is a graph of the group velocity delay time vs. wavelength characteristics of an optical dispersion compensating element of the present invention in which two elements are connected in series that are capable of performing dispersion compensation in which the shapes of the group velocity delay time vs. wavelength characteristics curves are nearly the same, but the wavelengths that impart the peak values (to be referred to as the extreme values) of the group velocity delay time vs. wavelength characteristics curves (to be referred to as the extreme value wavelengths) are different. FIG. 5C is a graph of the group velocity delay time vs. wavelength characteristics of an optical dispersion compensating element of the present invention in which three elements are connected in series that are capable of performing dispersion compensation in which the group velocity delay time vs. wavelength characteristics curves are nearly the same, but the extreme value wavelengths are different. FIG. 5D is graph of the group velocity delay time vs. wavelength characteristics of an optical dispersion compensating element of the present invention in which three elements are connected in series that are capable of performing dispersion compensation in which the shapes of the group velocity delay time vs. wavelength characteristics curves as well as the extreme value wavelengths are different. In these graphs, group velocity delay time is plotted on the vertical axis and wavelength is plotted on the horizontal axis.

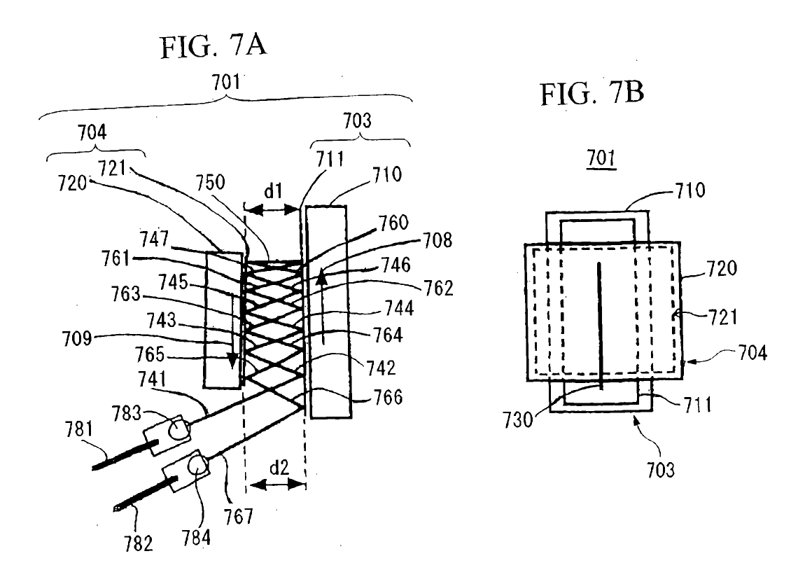

The basis of the optical dispersion compensation method of the present invention lies in a dispersion compensation method that compensates dispersion of signal light by composing a compound optical dispersion compensating element to be described later using, for example, FIGS. 7A and 7B, FIG. 8, and FIGS. 10A and 10B, using optical dispersion compensating elements having characteristics as shown in, for example, FIGS. 5A through 5D, connecting it in series with, for example, an optical fiber or disposing in the path of a signal light such as an amplifier, receiver, wavelength splitter, and various apparatuses of a relay station provided in a transmission path, and causing the signal light to enter the above optical dispersion compensating element.

In FIGS. 5A through 5D, reference symbols 301 through 309 indicate each group velocity delay time vs. wavelength characteristics curve of a single element capable of performing dispersion compensation used in the present invention, reference symbol 310 is a group velocity delay time vs. wavelength characteristics curve in the case of connecting in series two elements capable of performing dispersion compensation used in the present invention having nearly the same shape of group velocity delay time vs. wavelength characteristics curves but different extreme value wavelengths, reference symbol 311 is a group velocity delay time vs. wavelength characteristics curve in the case of connecting in series three elements capable of performing dispersion compensation used in the present invention having nearly the same shape of group velocity delay time vs. wavelength characteristics curves but different extreme value wavelengths, and reference symbol 312 is a group velocity delay time vs. wavelength characteristics curve in the case of connecting in series three elements capable of performing dispersion compensation used in the present invention having different shapes of group velocity delay time vs. wavelength characteristics curves and different extreme value wavelengths. Reference symbol a in FIG. 5A indicates the dispersion compensation target wavelength bandwidth (also referred to as the wavelength band or wavelength region), while reference symbol b indicates the extreme value of the group velocity delay time.

The bandwidths of the dispersion compensation target wavelength region and extreme values of group velocity delay time of curves 302 through 307 and 309 are nearly the same, while curve 308 indicates the group velocity delay time vs. wavelength characteristics curve in which the dispersion compensation target wavelength band is narrower than curves 307 and 309 and the extreme value of group velocity delay time is larger. Furthermore, as indicated in the drawings, the extreme value wavelengths of the above curves 302 through 309 are each different.

In FIGS. 5B and 5C, the extreme value of group velocity delay time of group velocity delay time vs. wavelength characteristics curve 310 is 1.6 times the case of a single element capable of performing dispersion compensation, and the dispersion compensation target wavelength region is about 1.8 times. The extreme value of group velocity delay time of group velocity delay time vs. wavelength characteristics curve 311 is about 2.3 times the case of a single element, and the dispersion compensation target wavelength region is about 2.5 times the case of a single element capable of performing dispersion compensation.

In FIG. 5D, the extreme value of group velocity delay time of the curve of group velocity delay time vs. wavelength characteristics curve 312 is about 3 times the case of a single element capable of performing dispersion compensation, and the dispersion compensation target wavelength region is about 2.3 times the case of a single element capable of performing dispersion compensation.

The extreme value of group velocity delay time and the dispersion compensation target wavelength region of the group velocity delay time vs. wavelength characteristics curve of an element capable of performing dispersion compensation using a multi-layer film as explained in FIGS. 2 through 4 vary according to the compositional conditions of each reflective layer and each light transmitting layer of the above multi-layer film, and in the manner of, for example, a group velocity delay time vs. wavelength characteristics curve in which the dispersion compensation target wavelength region is comparatively large but the extreme value of group velocity delay time is not that large as in curve 307 of FIG. 5D, or a group velocity delay time vs. wavelength characteristics curve in which the dispersion compensation target wavelength region is narrow but the extreme value of group velocity delay time is large as in curve 308, elements can be realized capable of performing dispersion compensation having various characteristics.

Multi-layer film A through multi-layer film H described in the previous section of disclosure of the invention are examples of such a multi-layer film used in an element capable of performing dispersion compensation. When elements capable of performing wavelength dispersion were produced using these multi-layer films A through H, group velocity delay time vs. wavelength characteristics curves were able to be realized in which the extreme value of group velocity delay time was 3 ps (picoseconds) and the dispersion compensation target wavelength region was 1.3-2.0 nm with respect to signal light of about 1.55 mm.

Although the above multi-layer films A through H are multi-layer films comprising two light transmitting layers, namely two cavities, juxtaposition between reflective layers in the direction of film thickness from the incident surface, the present invention is not limited to this, but rather multi-layer films can be used having various compositions such as three cavities or four cavities. The multi-layer film of the present invention is a multi-layer film having two or more cavities, and allows the obtaining of a group velocity delay time vs. wavelength characteristics curve that is completely different from multi-layer films having a single cavity. In particular, the use of a multi-layer film having four cavities demonstrates significant effects in the case of attempting to compensate large dispersion over a broad wavelength region.

The inventors of the present invention were able to realize an optical dispersion compensating element in which the dispersion compensation target wavelength region is 15 nm that has group velocity delay time vs. wavelength characteristics enabling compensation of dispersion due to optical fiber transmission by connecting in series a plurality of elements capable of performing dispersion compensation. When optical communications were carried out over a transmission distance of 60 km equivalent to 100 Gbps using an element capable of performing third order dispersion compensation of a 30-channel communications system in which the wavelength of the optical dispersion compensating element was around 1.55 met and the band wavelength width of each channel was 0.5 nm, communications were able to be carried out without any interference by third order dispersion.

In addition, by making suitable contrivances to select the group velocity delay time vs. wavelength characteristics of elements capable of performing dispersion compensation that are used by connecting in series, such as by combining the group velocity delay time vs. wavelength characteristics curve in FIG. 4 with the group velocity delay time vs. wavelength characteristics curve of a different shape in FIG. 5D, not only third order dispersion, but also second order dispersion can be compensated.

In an example of an optical dispersion compensating element in which at least two elements capable of performing dispersion compensation of the present invention are connected in series, in order to realize an optical dispersion compensating element having group velocity delay time vs. wavelength characteristics required to compensate third order dispersion, for example, it is desirable to use at least one element capable of performing wavelength dispersion that has a group velocity delay time vs. wavelength characteristics curve that has an extreme value in the dispersion compensation target wavelength region.

In addition, in order to more effectively perform dispersion compensation of a communications transmission path, it is desirable to improve the group velocity delay time vs. wavelength characteristics curve of the optical dispersion compensating element. As one method of accomplishing this, a means is used that is capable of adjusting the group velocity delay time vs. wavelength characteristics of the element capable of performing dispersion compensation.

As an example of such a method, a multi-layer film is formed by changing the film thickness of the light transmitting layers and reflective layers of the multi-layer film in a direction within the incident surface (namely, a direction parallel to the incident surface of the element) as explained using FIGS. 2 and 3, changing the relative incident position of signal light in an element capable of performing dispersion compensation, and changing the group velocity delay time vs. wavelength characteristics of the element capable of performing dispersion compensation. A means for changing the incident position of the incident light was realized by moving at least one of either optical dispersion compensating element 200 or the incident light relative to the position of the incident light. Various means for moving the above optical dispersion compensating element or incident light can be selected according to the particular circumstances, such as the conditions under which the optical dispersion compensating element is used, its cost and its characteristics. For example, a method in which movement is carried out by a manual means such as screws can be used in consideration of costs or the apparatus, or in order to make accurate adjustments or in order to allow adjustments to be made when unable to make adjustments manually, the use of an electromagnetic step motor or continuous drive motor is effective. In addition, the use of a piezoelectric motor using PZT (lead zirconate titanate) is also effective In addition by using a prism or dual core collimator that allows these methods to be combined, or by selecting the incident position by an optical means such as the use of an optical waveguide, the incident position can be selected both easily and accurately.

In addition, by providing a means for selecting the optical path in a compound optical dispersion compensating element of the present invention by coupling to the above compound optical dispersion compensating element, and selecting the optical path by using a means similar to the above incident position selection means, practical effects can be enhanced.

In addition, by allowing the air gap to be variable by using, for example, an air gap cavity for at least one of the cavities of the above multi-layer film, group velocity delay time vs. wavelength characteristics can be varied.

Each layer of a multi-layer film of an element capable of performing dispersion compensation used for the above optical wavelength dispersion compensating element of the present invention is composed of layer L, which is formed with a film produced by ion assist deposition (to also be referred to as an ion assist film) of SiO₂ having a thickness of a quarter wavelength, and layer H, which is formed with an ion assist film of TiO₂ having a thickness of a quarter wavelength. A layer that combines one layer of the above SiO₂ ion assist film (layer L) and one layer of the TiO₂ ion assist film (layer H) is referred to as one set of an LH layer, and for example, laminating five sets of LH layers refers to layering each layer, one layer at a time, in the order of layer L, layer H, layer L, layer H, layer L, layer H, layer L, layer H, layer L, and layer H.

Similarly, the above LL layer refers to one set of an LL layer formed by layering two layers L composed of an SiO₂ ion assist film having a thickness of a quarter wavelength. Thus, laminating three sets of LL layers, for example, refers to layering six layers L.

Furthermore, although the example of a dielectric was indicated for the composition of the film that forms layer H, the present invention is not limited to this, but rather examples of dielectric materials identical to TiO₂ in addition to TiO₂ that can be used include Ta₂O₅ and Nb₂O₅. Moreover, in addition to a dielectric material, layer H can also be formed using Si or Ge. In the case of forming layer H using Si or Ge, there is the advantage of being able to reduce the thickness of layer H. In addition, although the example of SiO₂ was indicated for the composition of layer L, and SiO₂ offers the advantages of being able to form layer L inexpensively and reliably, the present invention is not limited to this, but rather if layer L is formed by a material having a refractive index lower than the refractive index of layer H, an optical dispersion compensating element can be realized that demonstrates the above effects of the present invention.

In addition, in the present embodiment, although layer L and layer H constituting the above multi-layer film were formed by ion assist deposition, the present invention is not limited to this, but rather the present invention demonstrates significant effects even if using a multi-layer film formed by other methods such as ordinary deposition, sputtering and ion plating.

The optical dispersion compensating element of the present invention can be used by suitably holding that in the shape of a wafer as in multi-layer film 200 shown as an optical dispersion compensating element in FIG. 3. In addition, the optical dispersion compensating element can have a diverse range of forms, such as being able to be used as an optical dispersion compensating element by mounting in a cylindrical case along with, for example, a fiber collimator, by forming into the shape of a chip by cutting into small portions, for example, vertically in the direction of thickness, namely the direction from incident surface 220 to substrate 205, so as to include the portion required on incident surface 220. In any of these cases, the major effects explained in the present invention are demonstrated.

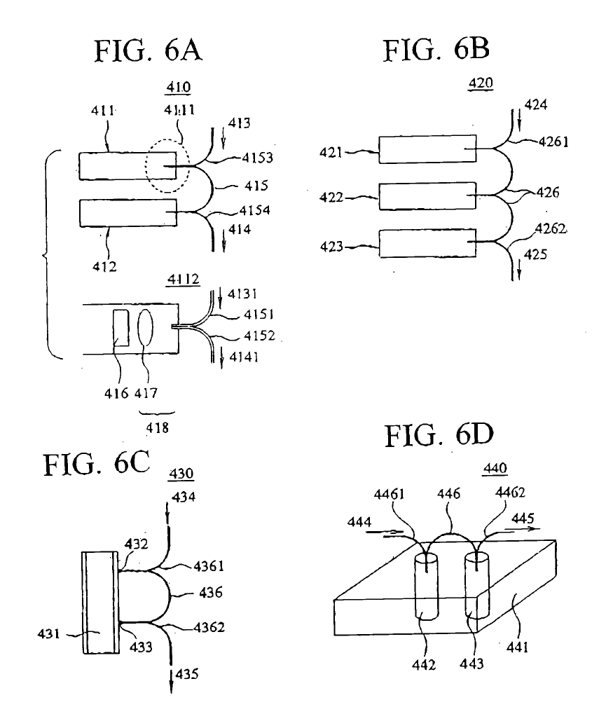

FIG. 6 shows drawings for explaining the method of connecting in series a plurality of elements capable of performing dispersion compensation in order to realize a group velocity delay time vs. wavelength characteristics curve like the examples shown in FIG. 5. FIG. 6A shows an example of composing an optical dispersion compensating element by connecting two of the above elements capable of performing dispersion compensation in series. FIG. 6B shows an example of composing an optical dispersion compensating element by connecting three of the above elements capable of performing dispersion compensation in series. FIG. 6C shows an example of composing an optical dispersion compensating element by connecting two incident positions of signal light in series along the optical path of the signal light on a multi-layer film in which film thickness varies in a direction within the incident surface. FIG. 6D shows an example of mounting an optical dispersion compensating element composed in the same manner as FIG. 6A in a single case.

In FIGS. 6A through 6D, reference symbols 410, 420, 430, and 440 indicate optical dispersion compensating elements composed by connecting in series a plurality of elements capable of performing dispersion compensation as previously described, reference symbols 411, 412, 421-423, 431, 442, and 443 indicate elements capable of performing dispersion compensation, reference symbol 416 indicates a multi-layer film used in an element capable of performing dispersion compensation, reference symbols 415, 4151-4154, 426, 4261, 4262, 436, 4361, 4362, 446, 4461, and 4462 indicate optical fibers, reference symbols 413, 4131, 414, 4141, 424, 425, 434, 435, 444, and 445 indicate arrows showing the direction of traveling of signal light, reference symbol 417 indicates a lens, reference symbol 418 indicates a dual core collimator composed with lens 417 and optical fibers 4151 and 4152, reference symbol 441 indicates a case, reference symbol 431 indicates an element capable of performing dispersion compensation in the form of a wafer composed so as to be able personal dispersion compensation by forming a multi-layer film, in which film thickness varies in a direction within the incident surface, on a substrate, and reference symbols 432 and 433 respectively indicate a “portion of an element capable of performing dispersion compensation”. In addition, among each of the above optical fibers, reference symbols 415, 4152, 426, 436, and 446 indicate optical fibers used as internal connection components and reference symbols 4151, 4153, 4154, 4261, 4262, 4361, 4362, 4461, and 4462 indicate optical fibers used as external connection components.

In FIG. 6A, signal light that has entered element 411 capable of performing dispersion compensation from optical fiber 4153 in the direction of arrow 413 is subjected to dispersion compensation, emitted from element 411 capable of performing dispersion compensation, enters element 412 capable of performing dispersion compensation by being transmitted through optical fiber 415, is emitted from element 412 capable of performing dispersion compensation after again being subjected to dispersion compensation, and is transmitted through optical fiber 4154 in the direction of arrow 414.

Reference symbol 4112 indicates the portion surrounded by broken line 4111 of element 411 capable of performing dispersion compensation, and is a drawing that explains its internal structure. Optical fibers 4151 and 4152 along with lens 417 compose dual core collimator 418, and signal light that has traveled through optical fiber 4151 in the direction of arrow 4131 passes through lens 417 and enters multi-layer film 416.

Multi-layer film 416 has, for example, group velocity delay time vs. wavelength characteristics as shown in FIG. 5A. Signal light that has entered multi-layer film 416 through optical fiber 4151 and lens 417 is subjected to third order dispersion compensation, is emitted from multi-layer film 416, again passes through lens 417, enters optical fiber 4152, travels in the direction of arrow 4141, and enters element 412 capable of performing dispersion compensation. In this case, optical fiber 4152 and optical fiber 415 are the same fiber, while optical fiber 4151 and optical fiber 4153 are also the same. Signal light that has been further subjected to dispersion compensation by element 412 capable of performing dispersion compensation is emitted from element 412 capable of performing dispersion compensation and travels through optical fiber 4154 in the direction shown with arrow 414.

This type of optical dispersion compensating element 410 shown in FIG. 6A has the group velocity delay time vs. wavelength characteristics shown in FIG. 5B, and signal light that has entered optical dispersion compensating element 410 is subjected to dispersion compensation corresponding to a group velocity delay time vs. wavelength characteristics curve like that shown in FIG. 5B, and the emitted from optical dispersion compensating element 410.

At this time, in the process in which signal light that has traveled through optical fiber 4151 in the direction of arrow 4131 enters multi-layer 416 through, for example, dual core collimator 418, is subjected to dispersion compensation, reflected with multi-layer film 416, enters optical fiber 4152 and is emitted in the direction of arrow 4141, the outgoing light of optical dispersion compensating element 410 that travels through optical fiber 4152 in the direction of arrow 4141 is subjected to coupling loss on the order of about 0.3-0.5 dB or more as compared with the incident light relative to the incident light of optical dispersion compensating element 410 in which signal light has traveled through optical fiber 4151 in the direction of arrow 4131. Although this loss is extremely small when compared with the case of dispersion compensation using a fiber grating of the prior art, in the case of desiring to perform dispersion compensation at even lower loss over a broad wavelength band of 15 nm or 30 nm, since the number of elements capable of performing dispersion compensation that are connected in series as explained in FIG. 5 becomes large, this coupling loss accumulates to result in considerable loss. For example, if ten elements capable of performing dispersion compensation are connected in series by the above connection method, coupling loss of 3-30 dB occurs. This loss becomes a serious problem when composing an optical dispersion compensating element of a broad wavelength band of 15 nm or 30 nm.

The object of the present invention is to provide an optical dispersion compensating element and optical dispersion compensation method that are capable of dispersion compensation at low loss even over a broad wavelength band, and this object is described later using FIGS. 7 through 10.

Prior to this description, a detailed description of dispersion compensation is provided to further facilitate understanding the present invention.

In optical dispersion compensating element 420 of FIG. 6B, in a similar process in which signal light, which has been transmitted through optical fiber 4261 from the direction of arrow 424 and has entered optical dispersion compensating element 420, first enters element 421 capable of performing dispersion compensation, is subjected to dispersion compensation, is emitted from element 421 capable of performing dispersion compensation, and sequentially enters elements 422-423 capable of performing dispersion compensation after being transmitted through optical fiber 426 and the emitted from those elements, signal light is subjected to dispersion compensation corresponding to a group velocity delay time vs. wavelength characteristics curve as shown in FIG. 5C, after which it is emitted from optical dispersion compensating element 420 and travels through optical fiber 4262 in the direction shown with arrow 425.

FIG. 6C shows optical dispersion compensating element 430 as an example of connecting in series along the optical path of a signal light “portions 432 and 433 of element 431 capable of performing dispersion compensation” formed on the same wafer instead of elements 411 and 412 capable of performing dispersion compensation of FIG. 6A, and the manner of being subjected to dispersion compensation is similar to that explained with respect to FIG. 6A.

However, it is clear from the above explanation that the manner of being subjected to dispersion compensation differs according to the group velocity delay time vs. wavelength characteristics of the elements capable of performing dispersion compensation.

FIG. 6D shows the composing of optical dispersion compensating element 440 by incorporating elements 442 and 443 capable of performing dispersion compensation similar to FIG. 6A in the same case 441, and connecting in series along a signal light communications path by optical fiber 446. Although not shown in the drawing, element 443 capable of performing dispersion compensation uses a multi-layer film in which film thickness varies in a direction within the incident surface of the multi-layer film explained using FIG. 3, and has a means that adjusts the incident position. Although that incident position adjustment means is not shown, it is able to adjust incident position using a control circuit provided in case 441 and an incident position adjustment means drive circuit controlled thereby. Signal light enters optical dispersion compensating element 440 by being transmitted through optical fiber 4461, and is emitted from optical dispersion compensating element 440 by being transmitted through optical fiber 4462.

In order to allow the wavelength band targeted for wavelength compensation to be widened in the optical dispersion compensating element and optical dispersion compensation method that uses it in the present invention, as was previously described, a plurality of elements capable of performing dispersion compensation using a multi-layer film should be connected in series in an optical path to compose the optical dispersion compensating element as explained using FIGS. 5A through 5D, and then compensating dispersion by using that dispersion compensating element.

However, as was explained using FIGS. 6A through 6D, in the case of connecting a plurality of elements capable of performing dispersion compensation of the present invention using a collimator, if the number of the above elements to be connected is large, optical loss caused by their connection becomes a serious problem. Therefore, the inventors of the present invention proposed a dispersion compensating element in the present invention that uses a connection method illustrated in FIGS. 7A, 7B, 8, 10A and 10B as a method for significantly reducing this optical loss caused by connection.

FIGS. 7A and 7B are drawings that explain a compound optical dispersion compensating element of the present invention. FIG. 7A is a side view while FIG. 7B is a drawing as viewed from above. The dotted lines in FIG. 7B are shown for the sake of convenience in explaining those portions that are not visible due to the portions above them.

In FIGS. 7A and 7B, reference symbol 701 indicates a compound optical dispersion compensating element, reference symbols 703 and 704 indicate optical dispersion compensating elements used in the present invention constituting the above compound optical dispersion compensating element 701, and as is explained below, are each examples of connecting in series along the optical path of signal light a plurality of elements capable of performing dispersion compensation used in the present invention, reference symbols 710 and 720 indicate substrates, reference symbols 711 and 721 indicate multi-layer films composed on the above substrates that have group velocity delay time vs. wavelength characteristics as previously described relative to incident light, reference symbol 730 indicates a line that schematically shows the position of the optical path of incident light to be described later shown in FIG. 7A, reference symbols 741-747, 750, and 760-766 indicate optical paths of incident light, reference symbol 767 indicates the optical path of outgoing light, reference symbols 781 and 782 indicate optical fibers, reference symbols 783 and 784 indicate lenses, and reference symbols 708 and 709 indicate arrows showing the direction in which film thickness varies of light transmitting layers that form a multi-layer film. Reference symbols d1 and d2 indicate gaps between optical dispersion compensating elements 703 and 704 at the respective positions shown in the drawing.

Compound optical dispersion compensating element 701 is composed of optical dispersion compensating elements 703 and 704 provided in opposition as shown in the drawings.

In FIG. 7A, signal light transmitted through optical fiber 781 passes through lens 783, enters optical dispersion compensating element 703 composed of optical dispersion compensating element 701 from optical path 741 is reflected after being subjected to dispersion compensation at the incident point (intersection of optical path 741 and multi-layer film 711) of multi-layer 711 in the form of an element capable of performing dispersion compensation, reaches optical dispersion compensating element 704 after passing along optical path 742, is reflected after being subjected to dispersion compensation at the incident point of multi-layer film 721 in the form of an element capable of performing dispersion compensation, is reflected after continuing to be alternatively subjected to dispersion compensation at the incident point of multi-layer film 711 or 721, respectively, in the form of element capable of performing dispersion compensation after passing along optical paths 743-747, is further reflected after being subjected to dispersion compensation at the incident point of multi-layer film 711 or 721, respectively, after passing along optical paths 760-766, is emitted from compound optical dispersion compensating element 701 along optical path 767 and enters optical fiber 782 from lens 784 follow by being transmitted through optical fiber 782.

As can be understood from the above explanation, optical dispersion compensating elements 703 and 704 are optical dispersion compensating elements in which elements capable of performing dispersion compensation at each incident point of the signal light (and each incident point is a reflecting point together with being an incident point) are connected in series along the incident light, namely the optical path of the signal light.

Optical dispersion compensating elements 703 and 704 constituting compound optical dispersion compensating element 701 are disposed in opposition by gap d1 at the top of the drawing and by gap d2 at the bottom of the drawing as shown in FIG. 7A. In this case, gap d1 is formed to be narrower than gap d2, and the direction of light that has entered multi-layer film 721 along optical path 741 until optical path 750 is from the opposite side as that of the case of optical path 746 relative to the normal of multi-layer film 721 at the incident position. The reflected direction is then inverted, and the light is emitted from optical path 767 sequentially along optical paths 760-766. In a preferable example, although not limited to such, by making the incident angle of incident light about 5 degrees relative to the normal of multi-layer film 711, making d1 10 mm, and making the beam diameter of the incident light of optical path 741 about 1 mm, satisfactory output light can be obtained from optical path 767.

In optical dispersion compensating elements 703 and 704, multi-layer films 711 and 721 are formed on substrates 710 and 720, respectively, and multi-layer films 711 and 721 are formed such that the thickness of the film constituting the multi-layer film moving from the bottom to top of the drawing varies in the same manner as explained using FIG. 3, although the direction of the variation differs from the case of FIG. 3 (namely, film thickness varies depending on the location).

As an example, the film thickness of multi-layer films 711 and 721 along with each light transmitting layer is formed so that it increases in the directions of arrows 708 and 709. Thus, the contents of dispersion compensation subjected to the incident light described above using FIG. 7A at each of the applicable positions of optical dispersion compensating elements 703 and 704 differ in compliance with that explained using FIG. 3, and the form, extreme values and extreme value wavelength of the group velocity delay time vs. wavelength characteristics curve at each position are different.

Signal light that has entered compound optical dispersion compensating element 701 from optical path 741, respectively been subjected to dispersion compensation with optical dispersion compensating elements 703 and 704, and emitted from optical path 767 is subjected to dispersion compensation in accordance with a group velocity delay time vs. wavelength characteristics curve that closely approximates the group velocity delay time vs. wavelength characteristics curve synthesized by the group velocity delay time vs. wavelength characteristics curves at each position of optical dispersion compensating elements 703 and 704 as will be described later using FIG. 9 for the same reason as previously described using FIGS. 5A through 5D.

In this case, optical loss occurs when the signal light enters or leaves the optical fiber and when it is reflected after being subjected to dispersion compensation in the optical dispersion compensating elements, with the former primarily resulting in coupling loss, and the latter primarily resulting in reflection loss.

In general, reflection loss is much less than coupling loss. Moreover, it has been determined through research by the inventors of the present invention that their properties are different. Namely, the above reflection loss at the point where dispersion compensation is performed occurs, for example, only in the vicinity of the wavelength that imparts an extreme value of the group velocity delay time vs. wavelength characteristics curve at that position, and that peak value is about 0.1 dB or less, and can essentially be ignored at other wavelengths.

The loss to which signal light is subjected after having entered compound optical dispersion compensating element 701 according to the present invention until it has been subjected to dispersion compensation as previously described and emitted is the above reflection loss at each incident point (which is also a reflection point), and is considerably reduced by the extent to which dispersion compensation of the same contents can be performed in comparison with coupling loss in the case of connecting elements capable of performing dispersion loss in series along the optical path of a signal light using optical fibers and lenses as explained in FIGS. 6A through 6D.

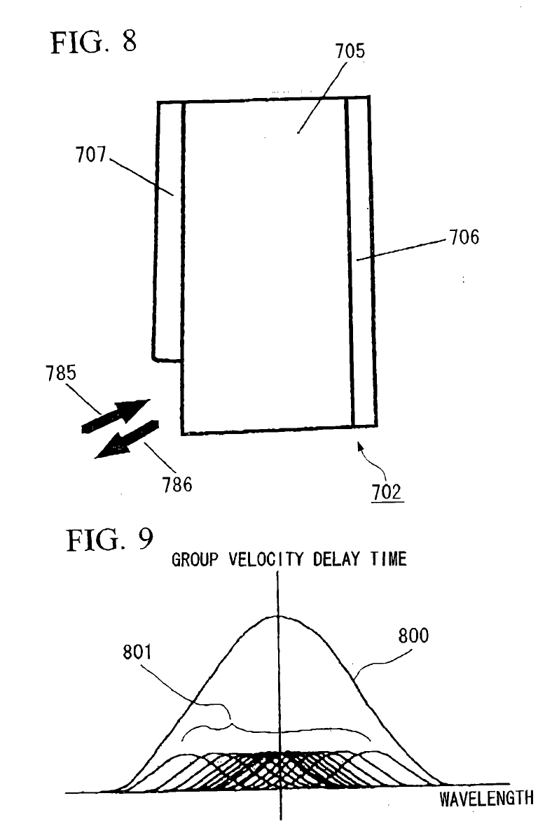

FIG. 8 is another example of a compound optical dispersion compensating element of the present invention. In the drawing, reference symbol 702 indicates a compound optical dispersion compensating element of the present invention, reference symbol 705 indicates a substrate, reference symbols 706 and 707 indicate optical dispersion compensating elements formed on the above substrate 705 that are composed of multi-layer films having group velocity delay time vs. wavelength characteristics as previously described relative to incident lights reference symbol 785 indicates an arrow showing the incident direction of signal lights and reference symbol 786 indicates an arrow showing the outgoing direction of signal light. Substrate 705 is formed so that it gradually becomes thicker from the top of the drawing to the bottom of the drawing, and is formed to have the same action as the actions of gaps d1 and d2 explained in FIG. 7A.

The multi-layer films constituting optical dispersion compensating elements 706 and 707 are formed so that the thickness of the film constituting the multi-layer films varies in the same manner as the case of FIG. 7A (namely, the thickness of the film varies depending on the position within the multi-layer film).

In FIG. 8, signal light that has entered compound optical dispersion compensating element 702 from arrow 785 travels to substrate 705, enters optical dispersion compensating element 706 or 707 where it is subjected to dispersion compensation, is reflected to a multi-layer film constituting optical dispersion compensating element 706 or 707, travels to substrate 705 and then is emitted in the direction of arrow 786 for the same reasons as in the case of FIG. 7A.

The multi-layer film constituting the above optical dispersion compensating element 706 or 707 as well as multi-layer films 711 and 721 have the action of performing dispersion compensation corresponding to group velocity delay time vs. wavelength characteristics on incident light in the same manner as explained using FIGS. 2 through 4.

Multi-layer films 711 and 721 of FIG. 7A are respectively formed on substrates 710 and 720, and have at least three reflective layers and at least two light transmitting layers. With respect to the reflectance of the reflective layers constituting each multi-layer film relative to the center wavelength of the incident light, each reflective layer is formed so that the next reflective layer provided interposed between the light transmitting layers near the above substrate of that reflective layer has a larger reflectance than the reflective layer present on the incident surface of incident light on the surface of each multi-layer film, or the reflective layer closest to the surface of each multi-layer film. Each multi-layer film has at least one reflective layer with a reflectance of 99.7% or more, and each reflective layer is formed so that the reflectance of each reflective layer present between the above reflective layers with a reflectance of 99.7% or more closest to the surface of the multi-layer film has a sequentially larger value in the direction of the substrate from the surface staling from the surface of the multi-layer film or the reflective layer closest to the surface. This reflective layer refers to both reflective layers on both sides of a light transmitting layer respectively being a single reflective layer, while the reflectance of each reflective layer refers to the reflectance of a single entire reflective layer as described above, and not to the reflectance of each unit film such as each layer H or layer L constituting each reflective layer.

The number of reflective layers and light transmitting layers in each multi-layer film of FIG. 7A can have numerous forms, such as the case of two cavities of three reflective layers and two light transmitting layers, the case of three cavities of four reflective layers and three light transmitting layers, or the case of four cavities of five reflective layers and four light transmitting layers, and the multi-layer film is used by composing according to the requirements of dispersion compensation.

Optical dispersion compensating elements 706 and 707 of FIG. 8 are also each composed of multi-layer films, and the having of at least three reflective layers and at least two light transmitting layers, and the having of at least one reflective layer with a reflectance of 99.7% or more, are the same as the case of FIG. 7A. However, the employing of a composition in which reflectance sequentially becomes larger from the reflective layer closest to the substrate to the reflective layer having reflectance of 99.7% or more as the reflective layers move farther away from the substrate is different from the case of FIG. 7A.

In addition, in FIG. 7, although gaps d1 and d2 of optical dispersion compensating elements 703 and 704 are such that d1<d2, by making the difference between d1 and d2 a suitable value, the positions of incident light and reflected light that enters optical dispersion compensating elements 703 and 704 disposed in opposition to each other can be on the same sides as optical dispersion compensating elements 703 and 704 disposed in opposition to each other as shown in FIG. 7A.

By changing the above difference between gaps d1 and d2, the positions of the above incident light and reflected light can also be on different sides of optical dispersion compensating elements 703 and 704 disposed in opposition to each other. Moreover, by making the above gaps d1 and d2 such that d1=d2, the above positions of incident light and reflected light can be made to be on the opposite side from the side on which incident light has entered the above optical dispersion compensating elements 703 and 704 disposed in opposition to each other (namely, on the side of optical path 750 and not the side of optical path 741).

FIG. 9 is a graph explaining the group velocity delay time vs. wavelength characteristics curve of compound optical dispersion compensating element 701 of FIG. 7A. In FIG. 9, reference symbol 801 indicates a group of group velocity delay time vs. wavelength characteristics curve as the aggregate of each group velocity delay time vs. wavelength characteristics curve at the incident position of each optical path of optical dispersion compensating elements 703 and 704 constituting compound optical dispersion compensating element 701, and as explained with arrows 708 and 709 of FIG. 7A, the directions of the variations in film thickness of multi-layer films 711 and 721 are the opposite, resulting in a group of laterally asymmetrical curves. Reference symbol 800 is the group velocity delay time vs. wavelength characteristics curve resulting from synthesis of all of the curves of the group of group velocity delay time vs. wavelength characteristics curves 801, namely is the group velocity delay time vs. wavelength characteristics curve of compound optical dispersion compensating element 701 according to the present invention.

In addition to having a larger extreme value and broader bandwidth than each curve of the group of group velocity delay time vs. wavelength characteristics curves 801, a characteristic of the group velocity delay time vs. wavelength characteristics curve of the above compound optical dispersion compensating element 701 is that, in comparison with the case of composing in the manner of FIGS. 6A through 6D by coupling using optical fibers and lenses, the loss of optical intensity is reduced significantly as previously described.

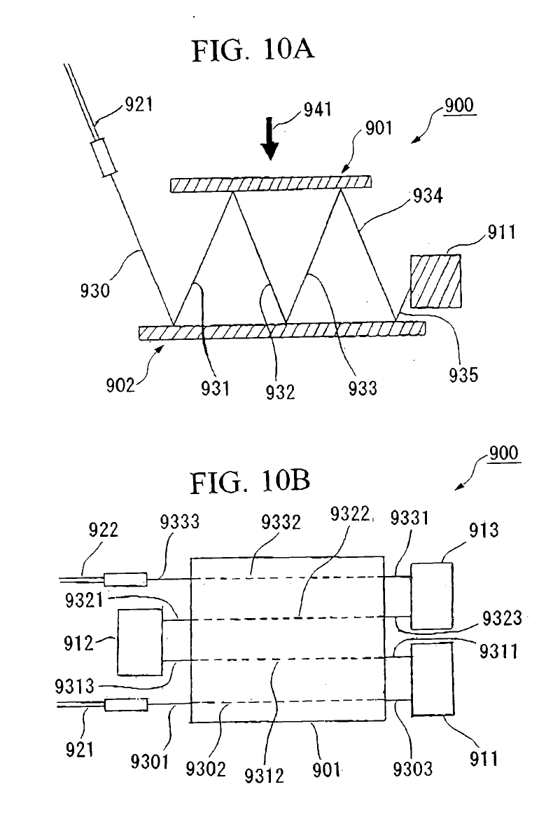

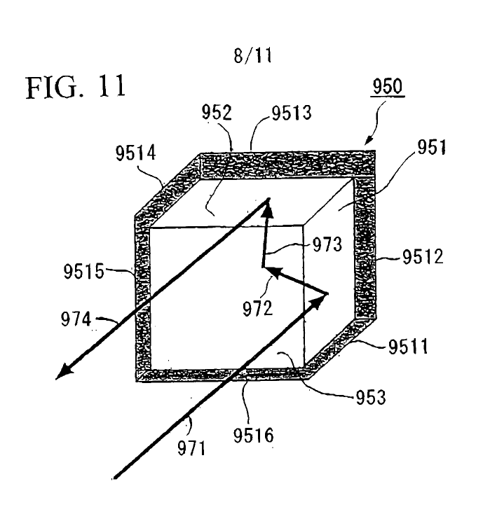

When compared with the single optical dispersion compensating element as explained in FIG. 5A, although the group velocity delay time in terms of the dispersion compensation wavelength bandwidth and amount of compensation can be made quite large in the case of the above group velocity delay time vs. wavelength characteristics curve of FIG. 9, communications systems require an even wider bandwidth and even greater compensation. A suitable form of the compound optical dispersion compensating element of the present invention that is able to satisfy such requirements is explained using FIGS. 10A, 10B and 11.

FIGS. 10A and 10B are drawings for explaining a particularly preferable mode for carrying out the compound optical dispersion compensating element of the present invention. FIG. 10A is a cross-sectional view that explains a pair of optical dispersion compensating elements 900 disposed by opposing the incident surfaces, which is one of the constituents of the compound optical dispersion compensating element of the present invention. FIG. 10B is a drawing of compound optical dispersion compensating element 900 of the present invention as viewed from the direction of arrow 941. FIG. 11 is a drawing showing a corner cube as an example of reflector 911 of FIGS. 10A and 10B. The dotted lines in FIG. 10B are shown for the sake of convenience in explaining those portions that are not visible due to being below the portions above them.

In FIGS. 10A, 10B and 11, reference symbol 900 indicates a pair of optical dispersion compensating elements disposed by opposing a pair of incident surfaces constituting a portion of the compound optical dispersion compensating element of the present invention, and this is also a compound optical dispersion compensating element of the present invention. Reference symbols 901 and 902 indicate optical dispersion compensating element units, reference symbols 911 through 913 indicate reflectors, reference symbols 921 and 922 indicate optical fibers, reference symbols 930-935, 9301-9303, 9311-9313, 9321-9323, 9331-9333, and 971-974 indicate optical paths of signal light, reference symbol 941 indicates an arrow, reference symbol 950 indicates a corner cubed, reference symbols 951-953 indicate reflective surfaces of corner cube 950, and reference symbols 9511-9516 indicate lines showing the cutting locations when cutting out a corner cube from a cube.

As shown in FIG. 10A, optical dispersion compensating element units 901 and 902 arc disposed so that the incident surfaces of the signal light are in opposition, and signal light that has been emitted from optical fiber 921 enters the incident surface of optical dispersion compensating element unit 902 along optical path 930, is subjected to dispersion compensation, reflected (namely, emitted from optical dispersion compensating element unit 902), and enters optical dispersion compensating element unit 901 along optical path 931 where it is subjected to dispersion compensation. Similarly, signal light that has been subjected to dispersion compensation with the above optical dispersion compensating element unit 901 travels to optical path 932 is again subjected to dispersion compensation with the above optical dispersion compensating element unit 901 and reflected, travels to optical path 934, is subjected to dispersion compensation with optical dispersion compensating element unit 902 and reflected, travels to optical path 935 and then enters reflector 911. Signal light that has entered reflector 911 is reflected with reflector 911, again enters the above optical dispersion compensating element unit 902 in parallel with but having the opposite orientation of optical path 935, and along an optical path, for example, that is slightly shifted towards the back of FIG. 10A, thereby resulting in the signal light being Subjected to several rounds of dispersion compensation with optical dispersion compensating element units 901 and 902 in the same manner as previously explained.

In addition, in the case of viewing the direction of traveling of the signal light explained above from the direction shown with arrow 941 of FIG. 10A, as shown in FIG. 10B, signal light emitted from optical fiber 921 travels along optical path 9301, enters the above optical dispersion compensating element unit 902 (since it is below optical dispersion compensating element unit 901, although not shown), travels along optical path 9302 while being subjected to several alternating rounds of dispersion compensation as explained above with the above optical dispersion compensating element units 901 and 902, is emitted from the above optical dispersion compensating element unit 902, travels along optical path 9303 and enters the above reflector 911.

Reflector 911 reflects light that has entered from optical path 9303 and emits the light to optical path 9311. Optical paths 9303 and 9311 are located at different positions of optical dispersion compensating element units 901 and 902 as shown in the drawings, are mutually in parallel and have the opposite orientation.

In this manner, signal light reflected with reflector 911 travels along optical path 9311, and then travels along optical path 9312 while again being subjected to a plurality of rounds of alternating dispersion compensation with optical dispersion compensating element units 902 and 901, and enters reflector 912 disposed on the opposite side of reflector 911 of optical dispersion compensating element 900.

Signal light reflected with the above reflector 912 travels along optical path 9321, and then travels along optical path 9322 while being subjected to a plurality of rounds of dispersion compensation with optical dispersion compensating element units 902 and 901, is emitted from the above optical dispersion compensating element unit 902, travels along optical path 9323 and enters reflector 913.

Signal light reflected with the above reflector 913 travels along optical path 9331, and then travels along optical path 9332 while being subjected to a plurality of rounds of dispersion compensation with optical dispersion compensating element units 902 and 901, is emitted from the above optical dispersion compensating element unit 902, travels along optical path 9333 and enters optical fiber 922. Although not shown in the drawing, lenses that form a collimator are disposed on the ends of optical fibers 921 and 922.

In addition, either of optical dispersion compensating element units 901 and 902 can be in the form of a mirror (reflecting plate), and in this case as well, signal light enters the optical dispersion compensating element units a plurality of times by the above mirror, and is subjected to a plurality of rounds of dispersion compensation.

The above optical paths 9313 and 9321 as well as optical paths 9323 and 9331 are at respectively different positions, are in parallel, and the directions in which light travels are opposite.

Furthermore, in FIGS. 10A and 10B, although an explanation has been provided of the case of the entrance and emission of signal light to and from a pair of optical dispersion compensating elements in which the incident surfaces are disposed in opposition being carried out in optical dispersion compensating element unit 902, the present invention is not limited to this, but rather entrance and emission of signal light may also be carried out in a different optical dispersion compensating element unit. In addition the optical dispersion compensating element unit into which the signal light enters can also be changed by changing the manner in which signal light enters, and in that case, can be realized by, for example, disposing the above reflectors 911 through 913 in a positional relationship in which a pair of reflectors are opposed in the direction parallel to arrow 941 of FIG. 10A. By then integrating the above pair of reflectors disposed in opposition into a single structure or integrating into a single unit with each dispersion compensating element unit, together with reducing the size of the optical dispersion compensating element, an optical dispersion compensating element can be provided having high reliability, is easily mounted aud has low volume production cost.

In addition, although the explanations in FIGS. 7A, 7B, 8, 10A and 10B have focused on a pair of optical dispersion compensating elements in which the incident surfaces are disposed in opposition, one of the optical dispersion compensating elements of the pair of optical dispersion compensating elements in which each incident surface is disposed in opposition, such as optical dispersion compensating elements 704 and 707 as well as optical dispersion compensating element unit 901, can each be replaced with a reflector, and be disposed while making the reflective surface of each of the above reflectors in opposition to each incident surface of optical dispersion compensating elements 703 and 706 as well as optical dispersion compensating element unit 902, to compose a compound optical dispersion compensating element similar to optical dispersion compensating elements 701, 702, and 900. This type of compound optical dispersion compensating element is also an optical dispersion compensating element of the present invention, and by suitably using according to the objective of dispersion compensation, considerable effects can be demonstrated.

Furthermore, optical paths similar to those explained above can be formed if the reflector in this case is made to have the same shape as the incident surfaces of optical dispersion compensating elements 704 and 707 as well as optical dispersion compensating element Lit 901.

In addition, as an example of reflectors 911 through 913, corner cube 950 shown in FIG. 11A can be used as a reflector. The above corner cube is composed of three mutually intersecting reflective surfaces consisting of reflective surfaces 951, 952, and 953. Reflective surfaces 951 through 953 are the surfaces on the inside of the coiner cube that is cut out of a cube (namely, the insides of the cube when a cube).

Signal light that has entered the above corner cube 950 along optical path 971 is reflected with reflective surface 951, enters reflective surface 952 along optical path 972, is reflected with reflective surface 952, enters reflective surface 953 along optical path 973, is reflected with reflective surface 953, and is emitted from coiner cube 950 along optical path 964,

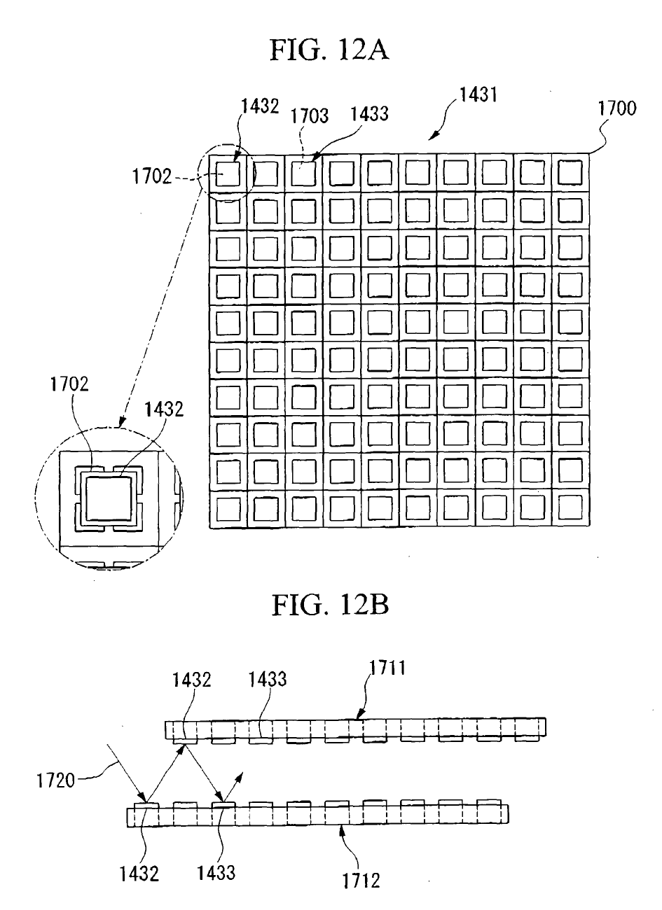

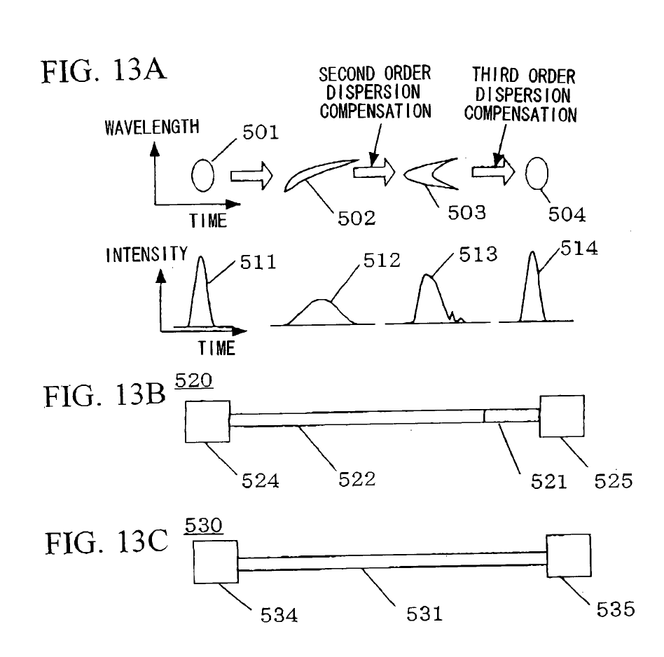

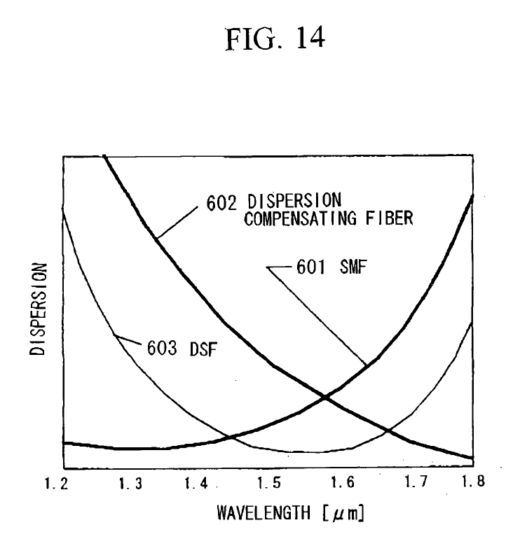

FIGS. 12A and 12B are drawings for explaining an embodiment of the present invention. In this example, semiconductor substrate 1700, for example, is used as the substrate of element 1431 capable of performing optical dispersion compensation, movable portions 1702 and 1703 disposed in the form of a matrix in the vertical and horizontal directions are formed on a surface on which are disposed portions 1432 and 1433 of element 14431 capable of performing dispersion compensation, elements capable of performing dispersion compensation, which are elements using a multi-layer film as explained using FIGS. 2 through 4 (also referred to as multi-layer film elements), are formed on the movable portions by using the movable portions as substrates, and a suitable number of these structures are produced (to also be referred to as matrix-shaped element plates).

Electrodes, for example, are disposed on the above movable portions of this matrix-shaped element plate, and the inclination of each movable portion in the matrix-shaped element plate surface is made to change according to the status of a voltage applied to the above electrodes. Thus, the perpendicular direction of the incident surface of elements capable of performing dispersion compensation composed on them changes.

Two plates each of an even number of these matrix-shaped element plates 1711 and 1712 are disposed so that the incident surfaces of elements capable of performing dispersion compensation composed on them are opposed, and so that incident light 1720 alternately enters the above opposed matrix-shaped elements plates 1711 and 1712. By then controlling the inclination of the incident surface of each element capable of performing dispersion compensation on the above opposing matrix-shaped element plates as necessary, and selecting the element capable of performing dispersion compensation that uses the optical path along which signal light passes, a group velocity delay time vs. wavelength characteristics curve like that shown in FIGS. 5B through 5D can be suitably realized by selecting the characteristics and quantity of elements capable of performing dispersion compensation connected in series. Here, with respect to the optical connection between each element capable of performing dispersion compensation, namely formation of the optical paths, although a fiber collimator as explained in FIGS. 6A through 6C or a reflector explained using FIGS. 10 and 11 can be used for connecting the portions of input/output terminals used as a dispersion compensating element overall or connecting between each set composed by disposing the above two plates each in opposition, this can be taken one step farther. Namely, by composing the formation of optical paths between incident surfaces of each element capable of performing dispersion compensation on matrix-shaped element plates disposed in opposition so as to be carried out by reflection between each incident surface, and selecting the combinations of reflective surfaces by, for example, electronic control combined with a computing apparatus, high-speed, rapid-switching of connections can be carried out in a compact size and with low loss.

For example, a dispersion compensating element can be composed by forming a 100×100 array namely 10,000, elements capable of performing dispersion compensation on each of the above matrix-shaped element plates, forming, for example, three sets of these matrix-shaped element plates in which two of these matrix-shaped element plates each are opposed, and forming optical paths by connecting a large number of elements capable of performing dispersion compensation in series in the optical path of a signal light, including the formation of optical paths by reflection between each element capable of performing dispersion compensation and the formation of optical paths by a fiber collimator. A plurality of optical paths can be formed for the same dispersion compensating element by suitably selecting a combination of the above elements capable of performing dispersion compensation using an electrical means and so forth according to the circumstances of the incident light.

Although the above has provided an explanation of an example in which an even number of matrix-shaped element plates are used, the present invention is not limited to this, but rather a single matrix-shaped element plate can also be used in opposition to a single wafer-shaped dispersion compensating element or a single reflecting plate.

It was confirmed by an experiment conducted by the inventors of the present invention that a matrix-shaped element plate on which are formed elements capable of performing dispersion compensation in this manner allows stable volume production by applying semiconductor production technology and multi-layer film formation technology.

Consequently, in addition to being able to reduce the insertion loss of the entire dispersion compensating element to an extremely low level, a compact dispersion compensating element can be provided at low cost that is able to perform multi-channel dispersion compensation with the same dispersion compensating element, allows rapid switching of dispersion compensation, and has extremely superior dispersion compensation characteristics.

As has been explained above, the major characteristic of the compound optical dispersion compensating element of the present invention is the composing of a pair of optical dispersion compensating elements in which the incident surfaces are in opposition, or a compound optical dispersion compensating element in which a plurality of optical dispersion compensating elements, that include at least a pair of optical dispersion compensating elements in which the incident surfaces are in opposition, are combined, along with the use thereof to perform dispersion compensation, reducing the lenses and optical fibers for connection, with the exception of the input ends and output ends of each optical dispersion compensating element composed in the manner described above, as much as possible, and being able to inexpensively provide an optical dispersion compensating element capable of performing dispersion compensation over a broad wavelength band with extremely low optical loss and at low cost.

In the above description, although the optical dispersion compensating element of the present invention was explained using the example of a set of optical dispersion compensating elements in which the incident surfaces are in opposition, and a compound optical dispersion compensating element in which the reflective surface of a reflector is disposed in opposition to the incident surfaces of optical dispersion compensating elements, the present invention is not limited to these, but rather that composed by combining a plurality of sets of optical dispersion compensating elements in which the incident surfaces are disposed in opposition as well as that in which optical dispersion compensating elements in which the incident surfaces are disposed in opposition are combined with optical dispersion compensating elements in which the incident surfaces are not disposed in opposition, are also included in the present invention.

Furthermore, according to the compound dispersion compensating element of the present invention and the dispersion compensation method for performing dispersion compensation that uses a dispersion compensating element composed in substantially the same manner thereof, the element and the method can be applied to communication systems handling not only broad wavelength bands such as 15 nm or 30 nm, but also narrow wavelength bands in optical communications such as 1 nin, and can also be applied to communication systems handling wavelength bands of 3 nm or 5-10 nm, and in any case, are able to demonstrate extremely significant effects as previously mentioned.

As a result of compensating dispersion in a communications system performing communications at a communication bit rate of 40 Gbps over a transmission distance of 60 km using a compound optical dispersion compensating element according to the present invention, in addition to being able to perform extremely satisfactory dispersion compensation, loss resulting from signal light passing through the optical dispersion compensating element was extremely low as compared with the case of performing dispersion compensation with only a collimator composed of lens and optical fibers.

Although the above has provided an explanation of an optical dispersion compensation method using the optical dispersion compensating element of the present invention while focusing primarily on the optical dispersion compensating element of the present invention and a compound optical dispersion compensating element using that element, the most noteworthy characteristic of the optical dispersion compensation method of the present invention is that, as a method of connecting a plurality of optical dispersion compensating elements in the optical path of signal light, for example, the signal light is made to repeatedly pass several times between the above pair of optical dispersion compensating elements, thereby making it possible to perform second order and third order dispersion compensation with low loss over abroad wavelength band while suppressing the loss that occurs from the time the signal light enters the above pair of optical dispersion compensating elements until the time it is emitted from them to only reflection loss, which is overwhelmingly small as compared with coupling loss.

Furthermore, although the above has provided an explanation of the best mode for carrying out the present invention under only one set of communications conditions, although easily understood from the diversity of optical communications, the best mode for carrying out the present invention can vary according to the communications system used and the required specifications of the communications system and so forth, and can be carried out by suitably selecting the previously described disclosed technology.

### INDUSTRIAL APPLICABILITY

Although the above has provided a detailed explanation of the present invention, according to the present invention, in addition to being able to perform satisfactory dispersion compensation of each channel by making available various group velocity delay time vs. wavelength characteristics curves using FIGS. 5B through 5D, satisfactory dispersion compensation can be performed for multiple channels. In addition to the dispersion compensation according to the optical dispersion compensating element of the present invention demonstrating particularly significant effects in third order dispersion compensation it is also capable of performing second order dispersion compensation by suitably adjusting the group velocity delay time vs. wavelength characteristics.

The present invention is essential for the practical application of high-speed, long-distance optical communications such as that over a transmission distance of 10,000 km at a communications bit rate of 40 Gbps, has a wide utilization range and greatly contributes to the development of the optical communications field.

Since the optical dispersion compensating element using a special multi-layer film according to the present invention is compact and suited for volume production, and can be provided at a low price, its contribution to the development of optical communications is extremely significant.

Finally, the use of the optical dispersion compensating element and optical dispersion compensation method of the present invention have significant socioeconomic effects as a result of enabling the use of numerous existing optical communications systems.

1. An optical dispersion compensating element that can be used in optical communication using optical fiber for communication transmission path, which is capable of performing dispersion compensation in a form of wavelength dispersion; wherein the optical dispersion compensating element comprises at least one multi-layer film element capable of performing dispersion compensation, which comprises a multi-layer film comprising at least three reflective layers with mutually different optical reflectance and at least two light transmitting layers formed between the reflective layers, and is composed by optically connecting a plurality of elements capable of performing dispersion compensation in a form of the multi-layer film elements, or a plurality of locations of a portion of an element capable of performing dispersion compensation, in series along an optical path of signal light.

2. The optical dispersion compensating element according to claim 1, wherein at least one multi-layer film constituting an optical dispersion compensating element comprises at least one reflective layer in which the reflectance relative to center wavelength λ of incident light is 99.7% or more, and, when signal light enters the multi-layer film, the reflectance of each reflective layer of the multi-layer film, starting from the incident surface to the first reflective layer having a reflectance of 99.7% or more, in the direction of thickness of the multi-layer film, gradually becomes larger from the side of the incident surface in the direction of thickness of the multi-layer film.

3. The optical dispersion compensating element according to claim 1, wherein at least one optical dispersion compensating element is formed on a semiconductor.

4. The optical dispersion compensating element according to claim 3, wherein at least a portion of the semiconductor on which an optical dispersion compensating element is formed is elastically deformable or movable.

5. The optical dispersion compensating element according to claim 1, wherein there are a plurality of connection methods or connection paths of a plurality of elements capable of performing dispersion compensation.

6. The optical dispersion compensating element according to claim 5, wherein the connection method or connection path of the plurality of elements capable of performing dispersion compensation is selected from an outside of the optical dispersion compensating element.

7. The optical dispersion compensating element according to claim 6, wherein at least one connection method of the plurality of elements capable of performing dispersion compensation is a method according to reflection on the incident surfaces of multi-layer film elements disposed in mutual opposition.

8. A compound optical dispersion compensating element combining optical dispersion compensating elements that can be used in communications using optical fiber for communication transmission path, which is capable of performing dispersion compensation in a form of wavelength dispersion; wherein at least a portion of optical dispersion compensating elements constituting the compound optical dispersion compensating element is composed such that at least one of at least a portion of an incident surface of a first optical dispersion compensating element and an incident surface of a second optical dispersion compensating element, which is different from the first optical dispersion compensating element disposed in opposition, and at least a portion of an incident surface of an optical dispersion compensating element selected from the first and second optical dispersion compensating elements and a reflective surface of a reflector referred to as reflector A below, disposed in opposition.

9. A compound optical dispersion compensating element according to claim 8, wherein at least a portion of the optical dispersion compensating elements constituting the compound optical dispersion compensating element are optical dispersion compensating elements comprising a multi-layer film element comprising a multi-layer film capable of performing compensating dispersion.

10. The compound optical dispersion compensating element according to claim 8, wherein at least one of the incident surface of the second optical dispersion compensating element disposed in opposition to the incident surface of signal light of the first optical dispersion compensating element and the reflective surface of the reflector A disposed in opposition to the incident surface of signal light of the optical dispersion compensating element, wherein the first and second optical dispersion compensating elements and/or the optical dispersion compensating element and the reflector A constitute the compound optical dispersion compensating element, is flat.

11. The compound optical dispersion compensating element according to claim 8, wherein at least one of the incident surface of the second optical dispersion compensating element disposed in opposition to the incident surface of signal light of the first dispersion compensating element and the reflective surface of the reflector A disposed in opposition to the incident surface of signal light of the first dispersion compensating element, wherein the first and second optical dispersion compensating elements and/or the optical dispersion compensating element and the reflector A constitute the compound optical dispersion compensating element, is curved.

12. The compound optical dispersion compensating element according to claim 9, wherein the multi-layer film element constituting at least one optical dispersion compensating element constituting the compound optical dispersion compensating element comprises a multi-layer film comprising at least three light reflecting layers also referred to as reflective layers and at least two light transmitting layers, and is formed such that each light transmitting layer is interposed between two of the reflective layers; and the multi-layer film comprises at least one reflective layer in which the reflectance relative to center wavelength λ of incident light is 99.7% or more, and the reflectance of each reflective layer disposed from the incident surface to a position of the first reflective layer having reflectance of 99.7% or more appearing first in a direction of thickness of the multi-layer film gradually becomes larger from the side of the incident surface in the direction of thickness of the multi-layer film.

13. The compound optical dispersion compensating element according to claim 8, wherein at least one optical dispersion compensating element constituting the compound optical dispersion compensating element is formed on a semiconductor.

14. The compound optical dispersion compensating element according to claim 13, wherein at least a portion of the semiconductor on which an optical dispersion compensating element is formed is elastically deformable or movable.

15. The compound optical dispersion compensating element according to claim 8, wherein a reflector or reflecting portion, also referred to as reflector B, which is different from either a first or second optical dispersion compensating element or reflector A, is provided in opposition to or in the vicinity of at least a portion of optical dispersion compensating elements composed such that at least one of at least a portion of an incident surface of a first optical dispersion compensating element and an incident surface of a second optical dispersion compensating element, which is different from the first optical dispersion compensating element, disposed in opposition, and at least a portion of an incident surface of an optical dispersion compensating element selected from the first and second optical dispersion compensating elements and a reflective surface of the reflector A, disposed in opposition, wherein the first and second optical dispersion compensating elements and/or the optical dispersion compensating element and the reflector A constitute the compound optical dispersion compensating element.

16. The compound optical dispersion compensating element according to claim 15, wherein reflector B is disposed so as to reflect light referred to as light A emitted from any one of a pair of optical dispersion compensating elements in which incident surfaces are disposed in mutual opposition, or emitted from any one of the reflective surface of an optical dispersion compensating element and reflector A arranged in opposition, and allow light A to enter the optical dispersion compensating element or reflector A.

17. The compound optical dispersion compensating element according to claim 16, wherein a location where light A enters as light referred to as light B reflected by reflector B is the optical dispersion compensating element or reflector A from which light A is emitted.

18. The compound optical dispersion compensating element according to claim 17, wherein an outgoing position of light A and an incident position of light B in the optical dispersion compensating element are different positions.

19. The compound optical dispersion compensating element according to claim 17, wherein light A and light B travel in parallel and in opposite directions.

20. The compound optical dispersion compensating element according to claim 15, wherein reflector B has at least three reflective surfaces.

21. The compound optical dispersion compensating element according to claim 20, wherein at least one of the reflective surfaces of reflector B is movable.

22. The compound optical dispersion compensating element according to claim 15, wherein at least a pair of reflectors B are provided on the same side of the end of a pair of optical dispersion compensating elements in which the incident surfaces are disposed in opposition, or an optical dispersion compensating element and reflector A disposed in opposition, or the pair of reflectors B are provided integrated into a single unit with at least one of a pair of optical dispersion compensating elements in which the incident surfaces are disposed in opposition, or at least one of an optical dispersion compensating element and reflector A disposed in opposition, so as to reflect either emitted light from any one of a pair of optical dispersion compensating elements in which the incident surfaces are disposed in opposition and each optical dispersion compensating element is also referred to as an optical dispersion compensating element unit, or emitted light from any one of reflector A and optical dispersion compensating element disposed in opposition.

23. The compound optical dispersion compensating element according to claim 15, wherein reflector B is a corner cube.

24. The compound optical dispersion compensating element according to claim 17, wherein a traveling direction of light B after entering either of a pair of optical dispersion compensating elements in which the incident surfaces are disposed in opposition, or after entering either an optical dispersion compensating element or reflector A disposed in opposition, is parallel and opposite to the traveling direction of light A which has traveled over the optical dispersion compensating element prior to being emitted.

25. The compound optical dispersion compensating element according to claim 15, wherein reflector B is provided corresponding to a plurality of locations in ends of a pair of optical dispersion compensating elements in which the incident surfaces are disposed in opposition, or ends of an optical dispersion compensating element and reflector A disposed in opposition.

26. The compound optical dispersion compensating element according to claim 25, wherein the traveling direction of signal light which travels while being subjected to dispersion compensation by entering the incident surface of each optical dispersion compensating element unit of a pair of optical dispersion compensating elements in which the incident surfaces are disposed in opposition is sequentially and alternately opposite at positions moving from one side of the incident surface to the other side of the incident surface, or by entering the incident surface of an optical dispersion compensating element disposed in opposition to reflector A, is sequentially and alternately opposite at positions moving from one side of the incident surface to the other side of reflector A.

27. The compound optical dispersion compensating element according to claim 9, wherein each optical dispersion compensating element unit of a pair of optical dispersion compensating elements in which the incident surfaces are disposed in opposition comprises a multi-layer film element formed on respectively different substrates.

28. The compound optical dispersion compensating element according to claim 9, wherein the multi-layer film of each optical dispersion compensating element unit of at least a pair of optical dispersion compensating elements in which the incident surfaces are disposed in opposition is formed on mutually opposing surfaces of a same substrate through which incident light is transmitted so that the incident surface is on the substrate side.

29. The compound optical dispersion compensating element according to claim 9, wherein reflectances of at least three reflective layers from a substrate side of a multi-layer film constituting an optical dispersion compensating element or at least one optical dispersion compensating element unit becomes larger moving from the reflective layer nearest the substrate to the reflective layer farthest from the substrate.

30. The compound optical dispersion compensating element according to claim 8, wherein an incident position and outgoing position of signal light on a pair of optical dispersion compensating elements in which at least one set of incident surfaces is disposed in opposition, or signal light of a pair of an optical dispersion compensating element and the reflective surface of reflector A disposed in opposition, are on mutually different sides of a pair of optical dispersion compensating elements in which the incident surfaces are disposed in opposition, or a pair of an optical dispersion compensating element and reflector A disposed in mutual opposition.

31. The compound optical dispersion compensating element according to claim 8, wherein an incident position and outgoing position of signal light on a pair of optical dispersion compensating elements in which at least one set of incident surfaces is disposed in opposition, or signal light on a pair of an optical dispersion compensating element and the reflective surface of reflector A is disposed in opposition, are on the same side of a pair of optical dispersion compensating elements in which the incident surfaces are disposed in opposition, or a pair of an optical dispersion compensating element and reflector A disposed in mutual opposition.

32. The compound optical dispersion compensating element according to claim 9, wherein at least one multi-layer film element comprises: a multi-layer film constituted of at least five kinds of laminated films of different optical properties, namely, at least five layers of laminated films with different optical properties such as optical reflectance and film thickness; the multi-layer film constituted of at least three kinds of reflective layers, including at least two kinds of reflective layers with mutually different optical reflectance, and at least two light transmitting layers in addition to the three types of reflective layers, each of the three types of reflective layers and each of the two light transmitting layers being alternately disposed; the multi-layer film constituted of a first layer in the form of a first reflective layer, a second layer in the form of a first light transmitting layer, a third layer in the form of a second reflective layer, a fourth layer in the form of a second light transmitting layer, and a fifth layer in the form of a third reflective layer, in that order, from one side in the direction of film thickness of the multi-layer film, wherein, when the center wavelength of the incident light is defined as λ, and the film thickness is defined as an optical path length relative to light of center wavelength λ of the incident light, the film thickness of each layer constituting the multi-layer film in the first through fifth layers is the film thickness of a value within a range of approximately an integer multiple of λ/4±1%, wherein the multi-layer film is constituted of a plurality of sets of layers combining a layer H, which is a layer having a higher refractive index and a film thickness of approximately λ/4±1%, and a layer L, which is a layer having a lower refractive index and a film thickness of approximately λ/4±1%; and,
wherein, when multi-layer film A is taken to be a multi-layer film in which five layers of laminated films, namely, first through fifth layers, are respectively formed, in order, from one side in the direction of thickness of the multi-layer film with a first layer composed by laminating three sets of HL layers in which one layer H and one layer L each are combined in order to make an HL layer, a second layer composed by laminating 10 sets of HH layers in which a layer H and a layer H are combined to make an HH layer, a third layer composed by laminating one layer L and seven sets of HL layers, a fourth layer composed by laminating 38 sets of HH layers, and a fifth layer composed by laminating one layer L and 13 sets of HL layers,
when multi-layer film B is taken to be a multi-layer film in which, in lieu of the second layer formed by laminating 10 sets of HH layers of multi-layer film A, the second layer is formed with a laminated film composed by laminating, in order, from one side in the direction of thickness of the film, which is the same direction as the case of multi-layer film A, three sets of HH layers, three sets of LL layers in which a layer L and a layer L are combined to make an LL layer, three sets of HH layers, two sets of LL layers and one set of HH layer,
when multi-layer film C is taken to be a multi-layer film in which, in lieu of the fourth layer formed by laminating 38 sets of HH layers of multi-layer film A or multi-layer film B, the fourth layer is formed with a laminated film composed by laminating, in order, from one side in the direction of thickness of the film, which is the same direction as the case of multi-layer film A, three sets of HH layers, three sets of LL layers, three sets of HH layers, three sets of LL layers, three sets of HH layers, three sets of LL layers, three sets of HH layers, three sets of LL layers, three sets of HH layers, three sets of LL layers, three sets of HH layers, three sets of LL layers, three sets of HH layers and three sets of LL layers and two sets of HH layers in that order,
when multi-layer film D is taken to be a multi-layer film in which five layers of laminated films, namely, first through fifth layers, are respectively formed, in order, from one side in the direction of thickness of the multi-layer film with a first layer composed by laminating five sets of LH layers in which one layer L and one layer H each are combined, in that order, to make an LH layer, a second layer composed by laminating seven sets of LL layers, a third layer composed by laminating one layer H and seven sets of LH layers, a fourth layer composed by laminating 57 sets of LL layers, and a fifth layer composed by laminating one layer H and 13 sets of LH layers,
when multi-layer film E is taken to be a multi-layer film in which five layers of laminated films, namely, first through fifth layers, are respectively formed, in order, from one side in the direction of thickness of the multi-layer film with a first layer composed by laminating two sets of HL layers, a second layer composed by laminating 14 sets of HH layers, a third layer composed by laminating one layer L and 6 sets of HL layers, a fourth layer composed by laminating 24 sets of HH layers, and a firth layer composed by laminating one layer L and 13 sets of HL layers,
when multi-layer film F is taken to be a multi-layer film in which, in lieu of the second layer formed by laminating 14 sets of HH layers of multi-layer film E, the second layer is formed with a laminated film composed by laminating, in order, from one side in the direction of thickness of the film, which is the same direction as the case of multi-layer film E, three sets of HH layers, three sets of LL layers, three sets of HH layers, three sets of LL layers, two sets of HH layers, one set of LL layer and one set of HH layer,
when multi-layer film G is taken to be a multi-layer film in which, in lieu of the fourth layer formed by laminating 24 sets of HH layers of multi-layer film E or multi-layer film F, the fourth layer is formed with a laminated film composed by laminating, in order, from one side in the direction of thickness of the film, which is the same direction as the case of multi-layer film E, three sets of HH layers, three sets of LL layers, three sets of HH layers, three sets of LL layers, three sets of HH layers, three sets of LL layers, three sets of HH layers, three sets of LL layers, two sets of HH layers, one set of LL layer, and one set of HH layer, and
when multi-layer film H is taken to be a multi-layer film in which five layers of laminated films, namely, first through fifth layers, are respectively formed, in order, from one side in the direction of thickness of the multi-layer film with a first layer composed by laminating one layer L and four sets of LH layers, a second layer composed by laminating 9 sets of LL layers, a third layer composed by laminating one layer H and six sets of LH layers, a fourth layer composed by laminating 35 sets of LL layers, and a fifth layer composed by laminating one layer H and 13 sets of LH layers,
at least one multi-layer film element comprises at least one of multi-layer films A through H.

33. The compound optical dispersion compensating element according to claim 9, wherein the film thickness of at least one laminated film constituting a multi-layer film of at least one optical dispersion compensating element varies in a direction within the laminated layer in a cross-section parallel to the incident surface of light of the multi-layer film, namely, in a direction within an incident surface, or in other words, a film thickness varies according to a position within the laminated film.

34. The compound optical dispersion compensating element according to claim 33, wherein the film thickness of at least one of the light transmitting layers of the multi-layer film of each optical dispersion compensating element unit of optical dispersion compensating elements constituting the compound optical dispersion compensating element, in which at least a pair of incident surfaces are disposed in mutual opposition, varies in a direction within the incident surface, and each direction in which film thickness varies is mutually different.

35. The compound optical dispersion compensating element according to claim 34, wherein the film thickness of at least one of each of light transmitting layers of the multi-layer film of each optical dispersion compensating element unit of optical dispersion compensating elements constituting the compound optical dispersion compensating element, in which at least a pair of incident surfaces are disposed in mutual opposition, varies in mutually opposite directions.

36. The compound optical dispersion compensating element according to claim 33, wherein an adjustment means which adjusts the film thickness of at least one laminated film of the multi-layer film, or a means which varies the incident position of light in the incident surface of the multi-layer film, is provided by coupling to an optical dispersion compensating element.

37. The compound optical dispersion compensating element according to claim 9, wherein at least one of the multi-layer film elements is an optical dispersion compensating element capable of compensating primarily third order dispersion.

38. The compound optical dispersion compensating element according to claim 9, wherein at least one of the optical dispersion compensating elements is an optical dispersion compensating element capable of compensating primarily second order dispersion.

39. The compound optical dispersion compensating element according to claim 8, wherein, among those optical dispersion compensating elements constituting the compound optical dispersion compensating element, at least a pair of an incident surface of a first optical dispersion compensating element and an incident surface of a second optical dispersion compensating element disposed in mutual opposition, or at least a pair of an incident surface of an optical dispersion compensating element and the reflective surface of reflector A disposed in mutual opposition, are disposed in close proximity to enable an entrance and reflection of incident light to the optical dispersion compensating element to be performed a plurality of times between the incident surface of the first optical dispersion compensating element and the incident surface of the second optical dispersion compensating element disposed in mutual opposition, or between the incident surface of the optical dispersion compensating element and the reflective surface of the reflector A disposed in mutual opposition.

40. The compound optical dispersion compensating element according to claim 39, wherein at least a portion of the optical dispersion compensating element constituting the compound optical dispersion compensating element is an optical dispersion compensating element comprising a so-called multi-layer film element, which is an element that uses a multi-layer film able to compensate dispersion.

41. The compound optical dispersion compensating element according to claim 39, wherein at least one of the incident surface of the second optical dispersion compensating element disposed in opposition to the incident surface of signal light of the first optical dispersion compensating element and the reflective surface of the reflector A disposed in opposition to the incident surface of signal light of the optical dispersion compensating element, wherein the first and second optical dispersion compensating elements and/or the optical dispersion compensating element and the reflector A constitute the compound optical dispersion compensating element, is flat.

42. The compound optical dispersion compensating element according to claim 39, wherein at least one of the incident surface of the second optical dispersion compensating element disposed in opposition to the incident surface of signal light of the first optical dispersion compensating element and the reflective surface of the reflector A disposed in opposition to the incident surface of signal light of the optical dispersion compensating element, wherein the first and second optical dispersion compensating elements and/or the optical dispersion compensating element and the reflector A constitute the compound optical dispersion compensating element, is curbed.

43. The compound optical dispersion compensating element according to claim 40, wherein the multi-layer film element constituting at least one optical dispersion compensating element constituting the compound optical dispersion compensating element comprises a multi-layer film comprising at least three light reflecting layers also referred to as reflective layers and at least two light transmitting layers, and formed such that each light transmitting layer is interposed between two of the reflective layers, and the multi-layer film comprises at least one reflective layer in which the reflectance relative to center wavelength λ of incident light is 99.7% or more, and the reflectance of each reflective layer disposed from the incident surface to a position of the first reflective layer having reflectance of 99.7% or more appearing first in a direction of thickness of the multi-layer film gradually becomes larger from the side of the incident surface in the direction of thickness of the multi-layer film.

44. The compound optical dispersion compensating element according to claim 39, wherein at least one optical dispersion compensating element constituting the compound optical dispersion compensating element is formed on a semiconductor.

45. The compound optical dispersion compensating element according to claim 44, wherein at least a portion of the semiconductor on which an optical dispersion compensating element is formed is elastically deformable or movable.

46. The compound optical dispersion compensating element according to claim 39, wherein a reflector or reflecting portion, also referred to as reflector B, which is different from either a first or second optical dispersion compensating element or reflector A, is provided in opposition to or in the vicinity of at least a portion of optical dispersion compensating elements composed such that at least one of at least a portion of an incident surface of signal light of a first optical dispersion compensating element and an incident surface of a second optical dispersion compensating element, which is different from the first optical dispersion compensating element disposed in opposition, and at least a portion of an incident surface of an optical dispersion compensating element selected from the first and second optical dispersion compensating elements and a reflective surface of the reflector A, disposed in opposition, wherein the first and second optical dispersion compensating elements and/or the optical dispersion compensating element and the reflector A constitute the compound optical dispersion compensating element.

47. The compound optical dispersion compensating element according to claim 46, wherein reflector B is disposed so as to reflect light referred to as light A emitted from any of the pair of optical dispersion compensating elements in which incident surfaces are disposed in opposition, or emitted from any one of the incident surface of an optical dispersion compensating element and the reflective surface of the reflector A mutually arranged in opposition, and to enter light A into the optical dispersion compensating element or the reflector A.

48. The compound optical dispersion compensating element according to claim 47, wherein a location where light A enters as light referred to as light B reflected by reflector B is the optical dispersion compensating element or reflector A from which light A is emitted.

49. The compound optical dispersion compensating element according to claim 48, wherein an outgoing position of light A and an incident position of light B in an optical dispersion compensating element are different positions.

50. The compound optical dispersion compensating element according to claim 48, wherein light A and light B travel in parallel and in opposite directions.

51. The compound optical dispersion compensating element according to claim 46, wherein reflector B has at least three reflective surfaces.

52. The compound optical dispersion compensating element according to claim 51, wherein at least one of the reflective surfaces of reflector B is movable.

53. The compound optical dispersion compensating element according to claim 46, wherein at least one pair of reflectors B are provided on the same side of the end of, or in the vicinity of the same side of the end of a pair of optical dispersion compensating elements in which the incident surfaces thereof are disposed in opposition, or an optical dispersion compensating element and reflector A disposed in opposition, or a pair of reflectors B are provided integrated into a single unit with at least one of a pair of optical dispersion compensating elements in which the incident surfaces are disposed in opposition, or at least one of an optical dispersion compensating element and reflector A disposed in opposition, so as to reflect either emitted light from any one of a pair of optical dispersion compensating elements in which the incident surfaces thereof are disposed in opposition and each optical dispersion compensating element is also referred to as an optical dispersion compensating element unit, or emitted light from any one of the reflector A and optical dispersion compensating element disposed in opposition.

54. The compound optical dispersion compensating element according to claim 46, wherein reflector B is a corner cube.

55. The compound optical dispersion compensating element according to claim 48, wherein a traveling direction of light B after entering either of a pair of optical dispersion compensating elements in which the incident surfaces are disposed in opposition, or after entering either an optical dispersion compensating element or reflector A disposed in opposition, is parallel and opposite to the traveling direction of light A which has traveled over the optical dispersion compensating element prior to being emitted.

56. The compound optical dispersion compensating element according to claim 46, wherein reflector B is provided corresponding to a plurality of locations in ends of a pair of optical dispersion compensating elements in which the incident surfaces are disposed in opposition, or ends of an optical dispersion compensating element and reflector A disposed in opposition.

57. The compound optical dispersion compensating element according to claim 56, wherein the traveling direction of signal light which travels while being subjected to dispersion compensation by entering the incident surface of each optical dispersion compensating element unit of a pair of optical dispersion compensating elements in which the incident surfaces are disposed in opposition, or by entering the incident surface of an optical dispersion compensating element disposed in opposition to reflector A, is sequentially and alternately opposite at positions moving from one side to the other side of the incident surface.

58. The compound optical dispersion compensating element according to claim 40, wherein each optical dispersion compensating element unit of a pair of optical dispersion compensating elements in which the incident surfaces are disposed in opposition is composed with a multi-layer film element formed on respectively different substrates.

59. The compound optical dispersion compensating element according to claim 40, wherein the multi-layer film of each optical dispersion compensating element unit of at least a pair of optical dispersion compensating elements in which the incident surfaces are disposed in opposition is formed on mutually opposing surfaces of the same substrate through which incident light is transmitted so that the incident surface is on the substrate side.

60. The compound optical dispersion compensating element according to claim 40, wherein reflectances of at least three reflective layers from a substrate side of a multi-layer film constituting an optical dispersion compensating element or at least one optical dispersion compensating element unit becomes larger moving from the reflective layer nearest the substrate to the reflective layer farthest from the substrate.

61. The compound optical dispersion compensating element according to claim 39, wherein an incident position and outgoing position of signal light on a pair of optical dispersion compensating elements in which at least one set of incident surfaces is disposed in opposition, or signal light of a pair of an optical dispersion compensating element and the reflective surface of reflector A disposed in opposition, are on mutually different sides of a pair of optical dispersion compensating elements in which the incident surfaces are disposed in opposition, or a pair of an optical dispersion compensating element and reflector A disposed in mutual opposition.

62. The compound optical dispersion compensating element according to claim 39, wherein an incident position and outgoing position of signal light on a pair of optical dispersion compensating elements in which at least one set of incident surfaces is disposed in opposition, or signal light on a pair of an optical dispersion compensating element and the reflective surface of reflector A are disposed in opposition, are on the same side of a pair of optical dispersion compensating elements in which the incident surfaces are disposed in opposition, or a pair of an optical dispersion compensating element and reflector A disposed in mutual opposition.

63. The compound optical dispersion compensating element according to claim 40, wherein at least one multi-layer film element comprises a multi-layer film constituted of at least five kinds of laminated films with different optical properties, namely, at least five layers of laminated films with different optical properties such as optical reflectance and film thickness; the multi-layer film constituted of at least three kinds of reflective layers, including at least two kinds of reflective layers with mutually different optical reflectance, and at least two light transmitting layers in addition to the three types of reflective layers, each of the three types of reflective layers and each of the two light transmitting layers being alternately disposed; and the multi-layer film constituted of a first layer in the form of a first reflective layer, a second layer in the form of a first light transmitting layer, a third layer in the form of a second reflective layer, a fourth layer in the form of a second light transmitting layer, and a fifth layer in the form of a third reflective layer, in that order, from one side in the direction of film thickness of the multi-layer film wherein, when the center wavelength of the incident light is defined as λ, and the film thickness is defined as an optical path length relative to light of center wavelength λ of the incident light, the film thickness of each layer constituting the multi-layer film in the first through fifth layers is the film thickness of a value within the range of approximately an integer multiple of λ/4±1%, wherein the multi-layer film is constituted at a plurality of sets of layers combining a layer H, which is a layer having a higher refractive index and a film thickness of approximately λ/4±1%, and a layer L, which is a layer having a lower refractive index and a film thickness of approximately λ/4±1%; and,
wherein, when multi-layer film A is taken to be a multi-layer film in which five layers of laminated films, namely, first through fifth layers, are respectively formed, in order, from one side in the direction of thickness of the multi-layer film with a first layer composed by laminating three sets of HL layers in which one layer H and one layer L each are combined in order to make an HL layer, a second layer composed by laminating 10 sets of HH layers in which a layer H and a layer H are combined to make an HH layer, a third layer composed by laminating one layer L and seven sets of HL layers, a fourth layer composed by laminating 38 sets of HH layers, and a fifth layer composed by laminating one layer L and 13 sets of HL layers,
when multi-layer film B is taken to be a multi-layer film in which, in lieu of the second layer formed by laminating 10 sets of HH layers of multi-layer film A, the second layer is formed with a laminated film composed by laminating, in order, from one side in the direction of thickness of the film, which is the same direction as the case of multi-layer film A, three sets of HH layers, three sets of LL layers in which a layer L and a layer L are combined to make an LL layer, three sets of HH layers, two sets of LL layers and one set of HH layer,
when multi-layer film C is taken to be a multi-layer film in which, in lieu of the fourth layer formed by laminating 38 sets of HH layers of multi-layer film A or multi-layer film B, the fourth layer is formed with a laminated film composed by laminating, in order, from one side in the direction of thickness of the film, which is the same direction as the case of multi-layer film A, three sets of HH layers, three sets of LL layers, three sets of HH layers, three sets of LL layers, three sets of HH layers, three sets of LL layers, three sets of HH layers, three sets of LL layers, three sets of HH layers, three sets of LL layers, three sets of HH layers, three sets of LL layers, three sets of HH layers and three sets of LL layers and two sets of HH layers,
when multi-layer film D is taken to be a multi-layer film in which five layers of laminated films, namely, first through fifth layers, are respectively formed, in order, from one side in the direction of thickness of the multi-layer film with a first layer composed by laminating five sets of LH layers in which one layer L and one layer H each are combined in that order to make an LH layer, a second layer composed by laminating seven sets of LL layers, a third layer composed by laminating one layer H and seven sets of LH layers, a fourth layer composed by laminating 57 sets of LL layers, and a fifth layer composed by laminating one layer H and 13 sets of LH layers,
when multi-layer film E is taken to be a multi-layer film in which five layers of laminated films, namely, first through fifth layers, are respectively formed, in order, from one side in the direction of thickness of the multi-layer film with a first layer composed by laminating two sets of HL layers, a second layer composed by laminating 14 sets of HH layers, a third layer composed by laminating one layer L and 6 sets of HL layers, a fourth layer composed by laminating 24 sets of HH layers, and a firth layer composed by laminating one layer L and 13 sets of HL layers,
when multi-layer film F is taken to be a multi-layer film in which, in lieu of the second layer formed by laminating 14 sets of HH layers of multi-layer film E, the second layer is formed with a laminated film composed by laminating, in order, from one side in the direction of thickness of the film, which is the same direction as the case of multi-layer film E, three sets of HH layers, three sets of LL layers, three sets of HH layers, three sets of LL layers, two sets of HH layers, one set of LL layer and one set of HH layer,
when multi-layer film G is taken to be a multi-layer film in which, in lieu of the fourth layer formed by laminating 24 sets of HH layers of multi-layer film E or multi-layer film F, the fourth layer is formed with a laminated film composed by laminating, in order, from one side in the direction of thickness of the film, which is the same direction as the case of multi-layer film E, three sets of HH layers, three sets of LL layers, three sets of HH layers, three sets of LL layers, three sets of HH layers, three sets of LL layers, three sets of HH layers, three sets of LL layers, two sets of HH layers, one set of LL layer, and one set of HH layer, and
when multi-layer film H is taken to be a multi-layer film in which five layers of laminated films, namely, first through fifth layers, are respectively formed, in order, from one side in the direction of thickness of the multi-layer film with a first layer composed by laminating one layer L and four sets of LH layers, a second layer composed by laminating 9 sets of LL layers, a third layer composed by laminating one layer H and six sets of LH layers, a fourth layer composed by laminating 35 sets of LL layers, and a fifth layer composed by laminating one layer H and 13 sets of LH layers,
at least one multi-layer film element comprises at least one of multi-layer films A through H.

64. The compound optical dispersion compensating element according to claim 40, wherein the film thickness of at least one laminated film constituting a multi-layer film of at least one optical dispersion compensating element varies in a direction within the laminated layer in a cross-section parallel to the incident surface of light of the multi-layer film, namely, in a direction within an incident surface, or in other words, film thickness varies according to a position within the laminated film.

65. The compound optical dispersion compensating element according to claim 64, wherein the film thickness of at least one of the light transmitting layers of the multi-layer film of each optical dispersion compensating element unit of optical dispersion compensating elements constituting the compound optical dispersion compensating element, in which at least a pair of incident surfaces are disposed in mutual opposition, varies in a direction within the incident surface, and each direction in which film thickness varies is mutually different.

66. The compound optical dispersion compensating element according to claim 65, wherein the film thickness of at least one of each of the light transmitting layers of the multi-layer film of each optical dispersion compensating element unit of optical dispersion compensating elements constituting the compound optical dispersion compensating element, in which at least a pair of incident surfaces are disposed in mutual opposition, varies in mutually opposite directions.

67. The compound optical dispersion compensating element according to claim 64, wherein an adjustment means which adjusts the film thickness of at least one laminated film of the multi-layer film, or a means which varies the incident position of light in the incident surface of the multi-layer film, is provided by coupling to an optical dispersion compensating element.

68. The compound optical dispersion compensating element according to claim 40, wherein at least one of the multi-layer film elements is an optical dispersion compensating element capable of compensating primarily third order dispersion.

69. The compound optical dispersion compensating element according to claim 40, wherein at least one of the optical dispersion compensating elements is an optical dispersion compensating element capable of compensating primarily second order dispersion.

70. An optical dispersion compensation method for performing communications by compensating dispersion using an optical dispersion compensating element comprising a multi-layer film capable of compensating dispersion in the form of wavelength dispersion in optical communications using an optical fiber for the communications transmission path; wherein dispersion compensation is performed by causing signal light to enter an optical dispersion compensating element composed by connecting in series along an optical path of a signal light a plurality of elements capable of performing dispersion compensation as multi-layer film elements using a multi-layer film comprising at least three reflective layers with mutually different optical reflectance and at least two light transmitting layers formed between those reflective layers, or at least a plurality of portions of an element capable of performing dispersion compensation as an element capable of performing dispersion compensation.

71. The optical dispersion compensation method according to claim 70, wherein the signal light transmitted through the optical fiber is passed through an optical dispersion compensating element before being split according to wavelength for each receiving channel, and at least third order dispersion of the second and third order dispersion occurring in the signal light is compensated.

72. The optical dispersion compensation method according to claim 70, wherein the optical dispersion compensating element composed by connecting in series a plurality of elements capable of performing dispersion compensation is composed so as to have a group velocity delay time vs. wavelength characteristics curve having at least one extreme value in at least one wavelength range of wavelength ranges of 1260-1360 nm, 1360-1460 nm, 1460-1530 nm, 1530-1565 nm, 1565-1625 nm, and 1625-1675 nm.

73. The optical dispersion compensation method according to claim 70, wherein a plurality of methods can be selected for the method of connecting elements capable of performing dispersion compensation in the optical path of the signal light.

74. The optical dispersion compensation method according to claim 70, wherein the multi-layer film used in at least one of the elements capable of performing dispersion compensation constituting the optical dispersion compensating element is a multi-layer film in which a film thickness of each layer of the multi-layer film when considering as the optical path length relative to light of center wavelength λ of incident light is a film thickness of the value of about an integer multiple of λ/4, and the multi-layer film is composed with a plurality of sets of layers combining a layer H, which is a layer having a higher refractive index and a film thickness of about λ/4, and a layer L, which is a layer having a lower refractive index and a film thickness of about λ/4; and layer H is formed with a layer selected from the group consisting of Si, Ge, TiO₂, Ta₂O₅, and Nb₂O₅.

75. The optical dispersion compensation method according to claim 70, wherein at least one multi-layer film element comprises a multi-layer film element using a multi-layer film in which the film thickness of at least one laminated film constituting the multi-layer film of the multi-layer film element varies in a direction within the laminated layer in a cross-section parallel to the incident surface of light of the multi-layer film, namely, in a direction within the incident surface.

76. The optical dispersion compensation method according to claim 74, wherein layer L is formed with a layer comprised of SiO₂.

77. An optical dispersion compensation method for performing dispersion compensation using an optical dispersion compensating element comprising a multi-layer film capable of performing dispersion compensation in the form of wavelength dispersion in optical communication using an optical fiber for a communication transmission path, comprising a step of allowing incident light to pass along an optical path to perform dispersion compensation of incident light by: disposing at least one of at least a portion of an incident surface of light entering a first optical dispersion compensating element and an incident surface of a second optical dispersion compensating element, which is different from the first optical dispersion compensating element, in mutual opposition, and at least a portion of an incident surface of light entering an optical dispersion compensating element selected from the first and second optical dispersion compensating elements and a reflective surface of a reflector referred to as a reflector A, in mutual opposition; disposing the incident surfaces of the first and second optical dispersion compensating elements, in mutual opposition, and/or the incident surface of the optical dispersion compensating element selected from the first and second optical dispersion compensating elements and the reflective surface of the reflector A, in mutual opposition, to form the optical path of incident light therebetween; and constituting a composite optical dispersion compensating element comprising at least a pair of optical dispersion compensating elements in which entrance and reflection of incident light, which has entered between both the incident surfaces or the incident surface and the reflective surface disposed in opposition, on the incident surface of the optical dispersion compensating elements while traveling along the optical path is performed a plurality of times.

78. The optical dispersion compensation method according to claim 77, wherein dispersion compensation of incident light is performed by disposing a reflector or reflecting portion to be referred to as reflector B corresponding to at least to a portion or the vicinity of at least a pair of optical dispersion compensating elements disposed in opposition or an optical dispersion compensating element and reflector A disposed in opposition.

79. The optical dispersion compensation method according to claim 78, wherein dispersion compensation of incident light is performed by disposing reflector B so as to reflect light referred to as light A emitted from any of the pair of optical dispersion compensating elements in which incident surfaces are disposed in opposition, or emitted from any one of the incident surface of an optical dispersion compensating element and the reflective surface of reflector A mutually arranged in opposition, and to enter light A into an optical dispersion compensating element or reflector A.

80. The optical dispersion compensation method according to claim 79, wherein dispersion compensation of incident light is performed by disposing the optical dispersion compensating elements and reflectors so that light reflected by reflector B to also be referred to as light B again enters the optical dispersion compensating element from which light A was emitted.

81. The optical dispersion compensation method according to claim 80, wherein the outgoing position of light A and the incident position of light B in an optical dispersion compensating element are different positions.

82. The optical dispersion compensation method according to claim 80, wherein light A and light B travel in parallel but in opposite directions.

83. The optical dispersion compensation method according to claim 77, wherein the film thickness of at least one laminated film constituting at least one multi-layer film varies in a direction within the surface in a cross-section parallel to the incident surface of light of the multi-layer film, namely, in a direction within the incident surface.

84. The optical dispersion compensation method according to claim 77, wherein an optical dispersion compensating element composed by connecting in series a plurality or a plurality of locations of elements capable of performing dispersion compensation comprising at least one multi-layer film is composed so as to have a group velocity delay time vs. wavelength characteristics curve having at least one extreme value in at least one wavelength range of wavelength ranges of 1260-1360 nm, 1360-1460 nm, 1460-1530 nm, 1530-1565 nm, 1565-1625 nm, and 1625-1675 nm.

85. The optical dispersion compensation method according to claim 77, wherein a plurality of methods can be selected for the method of connecting elements capable of performing dispersion compensation in the optical path of the signal light.
